(19) United States
(12) Patent Application Publication
(10) Pub. No.: US 2017/0210129 A1
(43) Pub. Date: Jul. 27, 2017

(54) NOZZLE PLATE, LIQUID DISCHARGE HEAD, LIQUID DISCHARGE DEVICE, LIQUID DISCHARGE APPARATUS, AND METHOD OF MAKING NOZZLE PLATE

(71) Applicants: Tomohiro TAMAI, Kanagawa (JP); Masahiro OHMORI, Kanagawa (JP); Toshiroh TOKUNO, Hyogo (JP)

(72) Inventors: Tomohiro TAMAI, Kanagawa (JP); Masahiro OHMORI, Kanagawa (JP); Toshiroh TOKUNO, Hyogo (JP)

(21) Appl. No.: 15/417,567

(22) Filed: Jan. 27, 2017

(30) Foreign Application Priority Data
Jan. 27, 2016 (JP) 2016-013731
Sep. 16, 2016 (JP) 2016-181764

(51) Int. Cl. B41J 2/14; B41J 2/16; B41J 2/165

(52) U.S. Cl. CPC B41J 2/1433; B41J 2/16535; B41J 2/1642; B41J 2/162

(57) ABSTRACT

A nozzle plate includes a nozzle substrate and a liquid-repellent film. The nozzle substrate includes a nozzle to discharge liquid. The liquid-repellent film is disposed on a liquid discharge side of the nozzle substrate and including a fluororesin having a fluorine-containing heterocyclic structure with ether linkage in a polytetrafluoroethylene (PTFE) skeleton. The liquid-repellent film includes a slope region that slopes in a direction in which a film thickness of the liquid-repellent film is smaller toward an edge of the nozzle in a peripheral portion of the nozzle.

### CROSS-REFERENCE TO RELATED APPLICATIONS

This patent application is based on and claims priority pursuant to 35 U.S.C. §119(a) to Japanese Patent Application Nos. 2016-013731 filed on Jan. 27, 2016 and 2016-181764 filed on Sep. 16, 2016 in the Japan Patent Office, the entire disclosure of each of which is hereby incorporated by reference herein.

### BACKGROUND

Technical Field

Embodiments of the present disclosure relate to a nozzle plate, a liquid discharge head, a liquid discharge device, a liquid discharge apparatus, and a method of making the nozzle plate.

Related Art

A liquid discharge head (droplet discharge head) includes a discharge a liquid-repellent film on a surface of a liquid discharge face side of the liquid discharge head.

As the liquid-repellent film, for example, Teflon (registered trademark) AF is used. As methods of forming the liquid-repellent film, for example, immersing method, transfer method, spray application method, spin coating method, wire bar application method, thermal deposition method, meniscus coating method are known. After film formation, for example, the liquid-repellent film is heated at a temperature equal to or higher than the glass transition temperature.

### SUMMARY

In an aspect of the present disclosure, there is provided a nozzle plate that includes a nozzle substrate and a liquid-repellent film. The nozzle substrate includes a nozzle to discharge liquid. The liquid-repellent film is disposed on a liquid discharge side of the nozzle substrate and including a fluororesin having a fluorine-containing heterocyclic structure with ether linkage in a polytetrafluoroethylene (PTFE) skeleton. The liquid-repellent film includes a slope region that slopes in a direction in which a film thickness of the liquid-repellent film is smaller toward an edge of the nozzle in a peripheral portion of the nozzle.

In another aspect of the present disclosure, there is provided a liquid discharge head including the nozzle plate.

In still another aspect of the present disclosure, there is provided a liquid discharge device including the liquid discharge head to discharge liquid.

In still yet another aspect of the present disclosure, there is provided a liquid discharge apparatus that includes the liquid discharge device to discharge the liquid.

In still yet another aspect of the present disclosure, there is provided a liquid discharge apparatus including the liquid discharge head to discharge the liquid.

In still yet another aspect of the present disclosure, there is provided a method of making the nozzle plate. The method includes forming the fluororesin on the nozzle substrate of metal including the nozzle by vapor deposition, and heating a film of the fluororesin at a temperature equal to or higher than a glass transition temperature of the fluororesin.

### BRIEF DESCRIPTION OF THE SEVERAL VIEWS OF THE DRAWINGS

The aforementioned and other aspects, features, and advantages of the present disclosure would be better understood by reference to the following detailed description when considered in connection with the accompanying drawings, wherein:

FIG. 1 is a plan view of a nozzle plate according to a first embodiment of the present disclosure;

FIG. 2 is an enlarged cross-sectional view of a nozzle portion of the nozzle plate;

FIG. 3 is a plan view of a nozzle orifice area in the present embodiment;

FIG. 4 is an enlarged cross-sectional view of a nozzle portion of the nozzle plate according to a second embodiment of the present disclosure;

FIG. 5 is a graph of an example of a change in the ratio of a heterocyclic structure with ether linkage to a heterocyclic skeleton with ether linkage and a change of glass transition temperature Tg;

FIG. 6 (including FIGS. 6A and 6B) is an illustration of an example of a method of making the nozzle plate according to an embodiment of the present disclosure;

FIG. 7 is an illustration of vacuum vapor deposition;

FIGS. 8A and 8B are pictures of a state of a liquid-repellent film before baking, taken by a scanning electron microscope (SEM);

FIGS. 9A and 9B are pictures of a state of a liquid-repellent film after baking, taken by the SEM;

FIGS. 10A and 10B are illustrations of a bonding step of the nozzle plate and other members;

FIGS. 11A and 11B are illustrations of a case in which the transfer of the liquid-repellent film occurs and a case in which the transfer of the liquid-repellent film does not occur;

FIG. 12 is a graph of an example of a change in temperature and a change in Martens hardness;

FIG. 13 is a cross-sectional view of a liquid discharge head according to an embodiment of the present disclosure, in a direction (longitudinal direction of an individual liquid chamber) perpendicular to a nozzle array direction in which nozzles are arrayed in row;

FIG. 14 is a cross-sectional view of the liquid discharge head of FIG. 13 cut in the nozzle array direction;

FIG. 15 is a plan view of a portion of a liquid discharge apparatus according to an embodiment of the present disclosure;

FIG. 16 is a side view of a portion of the liquid discharge apparatus of FIG. 15 including a liquid discharge device;

FIG. 17 is a plan view of a portion of another example of the liquid discharge device;

FIG. 18 is a front view of still another example of the liquid discharge device;

FIG. 19 is a perspective view of the liquid discharge head and the wiper in a third embodiment of the present disclosure;

FIG. 20 is an enlarged perspective view of a leading end of the wiper of FIG. 19;

FIG. 21 is a side view of the liquid discharge head and the wiper of FIG. 19 in a wiping state;

FIG. 22 is an enlarged view of a nozzle plate and the leading end of the wiper of FIG. 21 in the wiping state;

FIGS. 23A and 23B are pictures of a nozzle and a surrounding area of the nozzle, taken by an electron microscope;

FIG. 24 is a plan view of an example of the liquid discharge device including a maintenance unit with the wiper in the third embodiment;

FIG. 25 is an illustration of a deformable portion and positions of an example of the wiper in the third embodiment;

FIG. 26 is an illustration of a contact face of the wiper;

FIG. 27 is an enlarged view of the wiping of the wiper, the inter-nozzle distance, and the width of the contact face;

FIG. 28 is an illustration of an evaluation device for wiping resistance;

FIG. 29 is an illustration of ranks of wearing state of an edge of the wiper;

FIG. 30 is an illustration of ranks of drawn state of ink from a nozzle;

FIG. 31 is a table of evaluation results;

FIGS. 32A to 32D are side views of a configuration in which the width La of the contact face of the wiper is longer than the inter-nozzle distance Pn;

FIGS. 33A to 33D are plan views of a wiping face of the wiper;

FIGS. 34A to 34D are side views of a configuration in which the width La of the contact face of the wiper is shorter than the inter-nozzle distance Pn; and

FIGS. 35A to 35D are plan views of a wiping face of the wiper.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

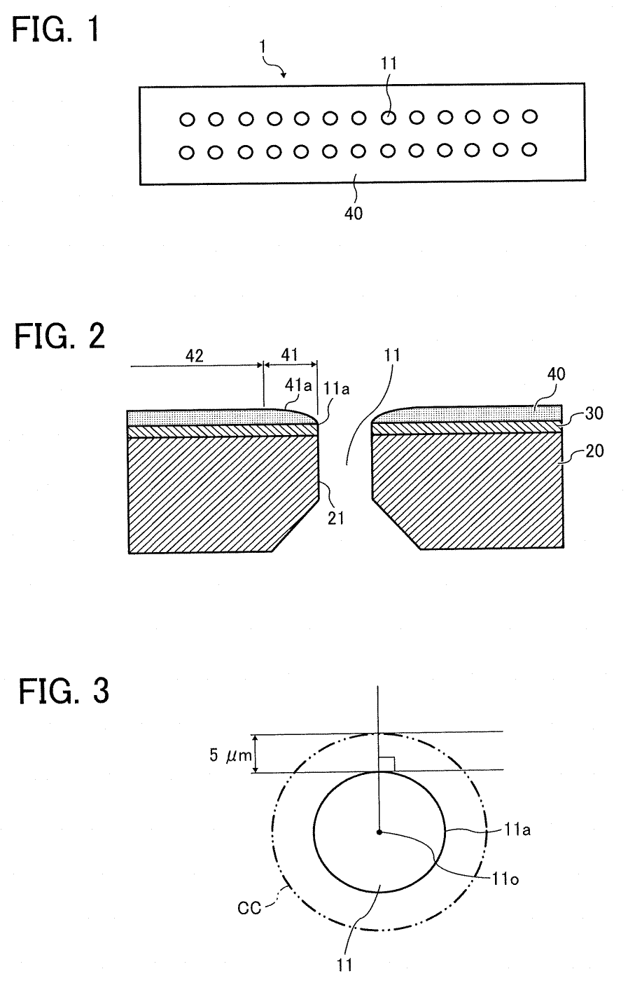

Below, embodiments of the present disclosure are described with reference to the attached drawings. A first embodiment of the present disclosure is described with reference to FIGS. 1 and 2. FIG. 1 is a plan view of a nozzle plate according to the first embodiment of the present disclosure. FIG. 2 is an enlarged cross-sectional view of a nozzle portion of the nozzle plate.

The nozzle plate 1 includes a nozzle substrate 20, an intermediated layer 30, and a liquid-repellent film 40. The nozzle substrate 20 has orifices (hereinafter nozzle orifices) 21 of nozzles 11 to discharge liquid. The intermediated layer 30 is disposed on a surface of the nozzle substrate 20. The liquid-repellent film 40 is disposed on a surface of a liquid discharge side of the nozzle plate 1 from which liquid is discharged.

The nozzle substrate 20 is, for example, a tabular metal member. In the present embodiment, as the nozzle substrate 20, a tabular metal member of stainless steel. However, the material of the nozzle substrate 20 is not limited to the stainless steel and may be any other suitable material.

The intermediated layer 30 includes one or more layers, such as a SiO₂ layer as a foundation layer and a silane-coupling-agent layer.

The liquid-repellent film 40 is a film including fluororesin having a fluorine-containing heterocyclic structure with ether linkage in a polytetrafluoroethylene (PTFE) skeleton.

The liquid-repellent film 40 includes slope regions 41 at peripheral portions of the nozzles 11. The slope region 41 has a slope 41a that slopes toward an edge 11a of the nozzle 11. At the slope 41a, the film thickness of the liquid-repellent film 40 is smaller toward the edge 11a of the nozzle 11. Note that the slope 41a of the slope region 41 may be curved or linearly slanted in cross section.

Note that a region 42 other than the slope region 41 of the liquid-repellent film 40 is substantially flat.

As described above, the liquid-repellent film 40 includes the slope regions 41 at the peripheral portions of the nozzles 11. At the slope regions 41, the film thickness of the liquid-repellent film 40 is smaller toward the edge 11a of each nozzle 11. Accordingly, a nozzle-side edge of the liquid-repellent film 40 around the nozzle 11 is located lower than a surrounding region of the liquid-repellent film 40 around the nozzle-side edge. Such a configuration prevents a wiper from interfering the edge of the liquid-repellent film 40, thus reducing or preventing the wiper from getting snagged on the edge of the liquid-repellent film 40.

Such a configuration can enhance the endurance of the liquid-repellent film 40.

In the present embodiment, the film thickness of the liquid-repellent film 40 is described with reference to FIG. 3. FIG. 3 is a plan view of a nozzle orifice area in the present embodiment.

As illustrated in FIG. 3, the film thickness of the liquid-repellent film 40 is measured at twenty points on a circumference CC. The circumference CC is apart from the edge 11a of the nozzles 11 by 5 nm on a normal of the edge 11a in a direction away from a nozzle center 11c. The arithmetic mean of population of the film thickness determined by the following Equation 1 is defined as mean film thickness “m”.

$$m = \frac{1}{N} {\sum }_{i = 1}^{N} {x}_{i} \qquad Equation 1$$

The amount determined by the following Equation 2 is defined as variance. The positive square root of variance is defined as standard deviation σ of population (of film thickness).

$${σ}^{2} = {\sum }_{i = 1}^{N} {( {x}_{i} - m )}^{2} \qquad Equation 2$$

Here, a smaller coefficient of variation of “standard deviation a of film thickness/mean film thickness “m” represents that the film thickness variance relative to the film thickness is smaller and the liquid-repellent film 40 is flatter.

A mean film thickness “a” on the circumference CC was measured equidistantly on the circumference CC at a spot diameter of φ 10 μm by an ellipsometer.

The presence or absence of remnant liquid on the surface after wiping was evaluated with different values of σ/m. When σ/m is 0.03, 0.06, and 0.09, no remnant liquid was observed. When σ/m=0.12 and 0.15, remnant liquid was observed. When remnant liquid is absent, no jetting deflection of discharged liquid occurs.

Accordingly, setting σ/m to less than 0.1 can reduce the jetting deflection.

In addition, the relation of c<d is preferably satisfied, where “c” represents the number average molecular weight of the fluororesin having the fluorine-containing heterocyclic structure with ether linkage in the PTFE skeleton in an interface with a foundation and “d” represents the number average molecular weight of the fluororesin in an uppermost surface of the liquid-repellent film 40.

In other words, as the molecular weight is lower, in high-temperature environment, the molecular mobility is higher and the bonding state with the base is better. By contrast, as the molecular weight is higher, the endurance against physical abrasion on the uppermost surface of the liquid-repellent film 40 directly contacting the wiper is higher.

Regarding the molecular weight in a direction of depth of the liquid-repellent film 40, lower molecular weights of substances evaporates earlier as the temperature is gradually raised. Therefore, the relation of c<d can be achieved by controlling the temperature in vapor deposition of resin.

Note that the mean molecular weight of resin in the liquid-repellent film 40 was measured by gel permeation chromatography (GPC). Results of the measurement were c=2,400,0000 and d=2,900,000.

For the intermediated layer 30, a layer being a foundation of the liquid-repellent film 40 is preferably an amino silane coupling agent layer.

Thus, higher bonding can be achieved by interaction between the amino group and the liquid-repellent material.

The film thickness of the liquid-repellent film 40 is preferably in a range of from 1 μm or greater and 3 μm or less.

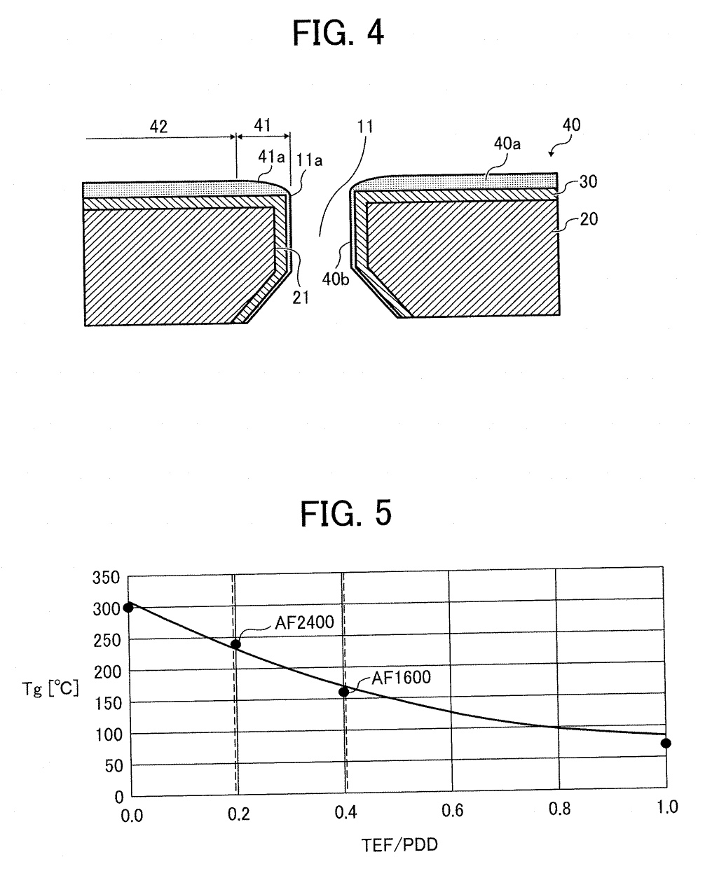

Next, a second embodiment of the present disclosure is described with reference to FIG. 4. FIG. 4 is an enlarged cross-sectional view of a single nozzle portion of the nozzle plate according to the second embodiment of the present disclosure.

For the nozzle plate 1 in the present embodiment, the intermediated layer 30 is also disposed on inner sides of the nozzle orifices 21 of the nozzle substrate 20, and the liquid-repellent film 40 is disposed on inner sides of the nozzles 11.

In the present embodiment, the film thickness t2 of a liquid-repellent film 40b on the inner side of the nozzle 11 (corresponding to the wall surface of the nozzle orifice 21 of the nozzle substrate 20) is preferably one tenth or less of the film thickness t1 of a region 42 of the liquid-repellent film 40a (t2/t1<0.1).

The film thickness t2 of the liquid-repellent film 40a in the wall surface of the nozzle 11 is preferably thinner since the variation in nozzle diameter is greater as the film thickness is greater. By contrast, as the film thickness t1 of the liquid-repellent film 40a on the liquid discharge side is greater, the endurance is higher.

The liquid-repellent film 40 having such mutually-contradictory film thicknesses can be obtained by film formation using a gas phase method.

Note that film thickness can be measured by exposing a cross section of the nozzle by ion polishing and observing the cross section with a scanning electron microscope (SEM).

The relationship between the film thickness t2 of the liquid-repellent film 40b on the inner side of the nozzle 11 and the film thickness t1 of the region 42 was evaluated. Note that, when the ratio of t2/t1 is greater than 0.1, the liquid-repellent film was formed by dipping method. Then, dipping liquid inflowing into the nozzle was blown out by blowing a wind into the nozzle and dried with the nozzle opened. Thus, a sample was obtained.

Results of the presence or absence of jetting deflection were that when t2/t1 is less than 0.05 and t2/t1 is less than 0.10, no jetting deflection was observed. When t2/t1 is equal to or greater than 0.3, jetting deflection was observed. Accordingly, when the relation of t2/t1<0.10 is satisfied, jetting deflection can be reduced or prevented.

Next, the liquid-repellent film in each of the above-described embodiments is described below.

The liquid-repellent film 40 is a film containing fluororesin having the fluorine-containing heterocyclic structure with ether linkage in the PTFE skeleton (hereinafter, also referred to as simply “fluororesin”). Fluororesin preferably has a glass transition temperature Tg equal to or higher than a room temperature.

The PTFE skeleton is a principal chain in which a structure unit of tetrafluoroethylene (TFE) represented by the following Chemical Formula 1 is repeated.

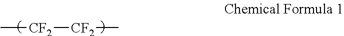

The fluorine-containing heterocyclic structure having ether linkage is a structure of an organic compound of five- to eight-membered ring including one or two oxygen atoms as heteroatom in chemical structural formula.

In consideration of liquid repellency (contact angle), the content of fluorine in fluororesin is preferably equal to or higher than 50 weight %. The percentage of ring structure in the principal chain is preferably equal to or higher than 20 weight %, more preferably equal to or higher than 30 weight % in consideration of, e.g., a target coating strength, the solubility to a solvent, or bonding to the nozzle substrate.

As the fluororesin, in particular, amorphous fluororesin is preferably used. Amorphous fluororesin is good in, e.g., film strength, bonding to the substrate, and uniformity of the film. Accordingly, advantages of the above-described embodiments can be more easily achieved.

The structure unit having the fluorine-containing heterocyclic structure with ether linkage is represented by, for example, the following structural formulae 2 through 6.

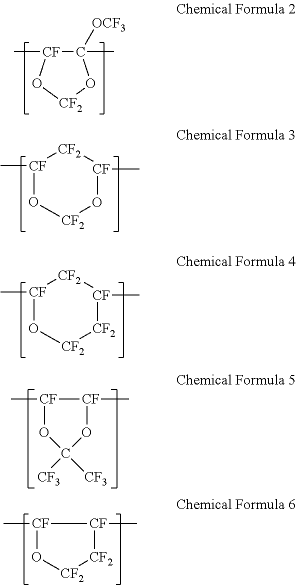

The fluororesin having the fluorine-containing heterocyclic structure with the ether linkage of the structure unit represented by the above-described Chemical Formula 5 in the PTFE skeleton is commercialized in the trade name of Teflon® AF by E. I. du Pont de Nemours and Company. Teflon® AF is a copolymer [TFE/PDD: tetrafluoroethylene-perfluorodioxol copolymer] having a tetrafluoroethylene structure and a dioxol structure with perfluoroalkyl group, and is preferable in that liquid repellency to various types of liquid is good.

The above-described tetrafluoroethylene-perfluorodioxol copolymer is an amorphous fluororesin and a transparent resin. The tetrafluoroethylene-perfluorodioxol copolymer may be a commercial product or be synthesized as needed.

As illustrated in FIG. 5, the glass transition temperature of the above-described tetrafluoroethylene-perfluorodioxol copolymer rises as the ratio of the perfluorodioxol (PDD) component relative to tetrafluoroethylene (TEE) component is higher. Commercial products are, for example, Teflon AF1600 having a glass transition temperature of 160° C. and Teflon AF2400 having a glass transition temperature of 240° C.

Note that FIG. 5 is a graph of relationship between the glass transition temperature and the ratio of TFE and PDD in the tetrafluoroethylene-perfluorodioxol (TFE/PDD) copolymer.

The fluororesin having the fluorine-containing heterocyclic structure with the ether linkage of the structure unit represented by the above-described Chemical Formula 2 in the PTFE skeleton is commercialized in the trade name of Hyflon® by Solvay Solexis.

The fluororesin having the fluorine-containing heterocyclic structure with the ether linkage of the structure unit represented by the above-described Chemical Formula 6 in the PTFE skeleton is commercialized in the trade name of CYTOP CTX-105 or CYTOP CTX-805 by Asahi Glass Co., Ltd.

As described above, the mean thickness of the liquid-repellent film 40 (fluororesin layer) is preferably in a range of from 1 μm to 3 μm.

A film thickness of 1 μm or greater is used to obtain a smooth surface without influence of unevenness of the nozzle substrate 20 to the surface of the fluororesin layer constituting the liquid-repellent film 40. The film thickness is preferably smaller in view of the maintenance of the shape and diameter of the nozzle 11. The mean thickness of the liquid-repellent film 40 is preferably in the range of from 1 μm to 3 μm in view of both the endurance against wiping and the shape of the nozzle 11. The mean thickness can be measured by, for example, a cross section SEM.

The arithmetic average roughness Ra of the liquid-repellent film 40 (fluororesin layer) is preferably 1.0 nm or less. When the arithmetic average roughness Ra is equal to or less than 1.0 nm, the nozzle face is extremely smooth and little liquid remains on the liquid-repellent film 40 after wiping. In addition, good abrasion resistance is obtained.

The arithmetic average roughness Ra is defined as follow. Extracting only a reference length from a roughness curve to an average line of the roughness curve in a section of a length I, X axis is defined by a direction of the average line of the extracted portion and Y axis is defined by a direction of longitudinal magnification. When the roughness curve is represented by y=f(x), the arithmetic average roughness Ra is a value determined by the following Equation 3 and represented in unit of micrometer (μm).

$$Ra = \frac{1}{l} {\int }_{0}^{l} \vert f ( x ) \vert dx \qquad Equation 3$$

Note that the arithmetic average roughness Ra was measured by a force tapping mode (in the air) of an atomic force microscope (DimensionIcon manufactured by Bruker-AXS K.K. Co., Ltd.). As a cantilever, a low-spring-constant silicon cantilever (OMCL-AC240TS-C3 manufactured by Olympus Corporation) is used. The measurement length was set to 10 μm.

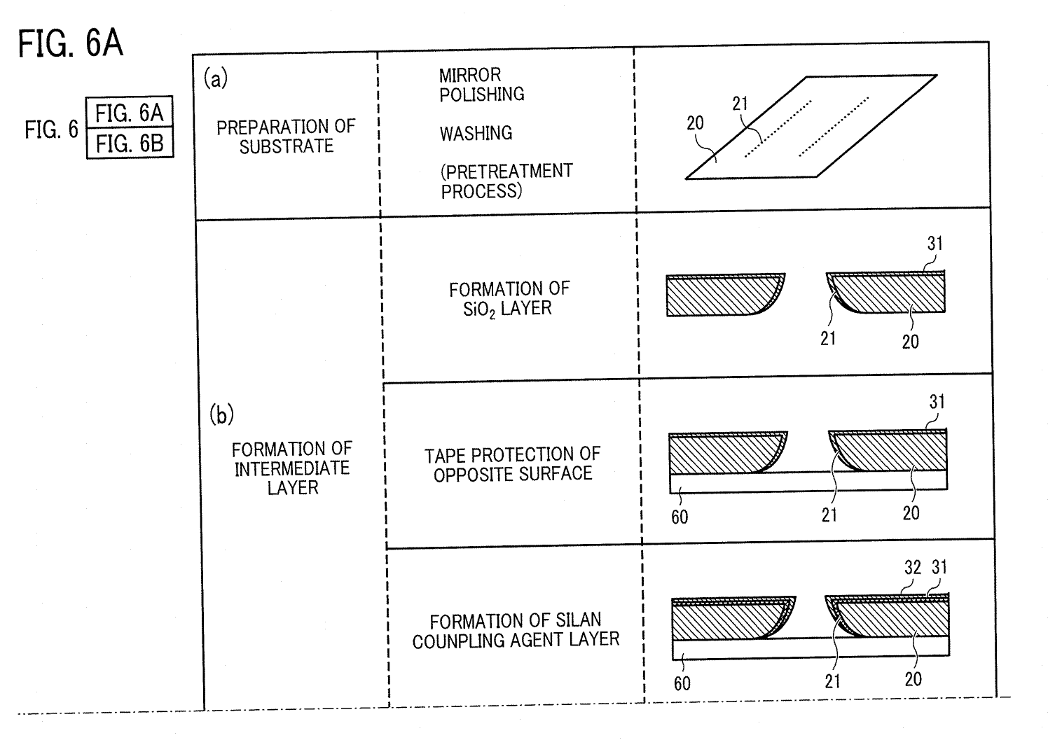

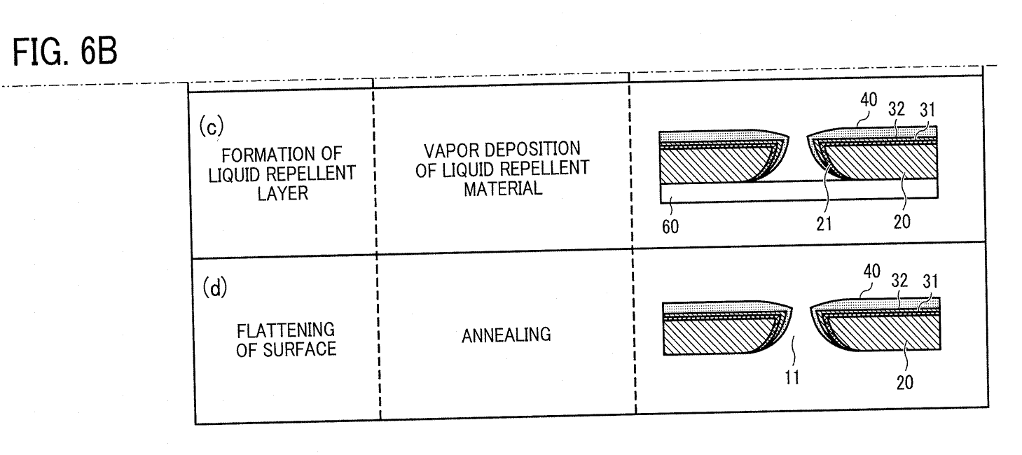

Next, an example of the method of making the nozzle plate according to an embodiment of the present disclosure is described with reference to FIGS. 6A and 6B. FIGS. 6A and 6B (collectively referred to as FIG. 6) is an illustration of an example of the method.

In a substrate preparation step illustrated in (a) of FIG. 6A, a preparation step is performed on a tabular metal member, which is processed into the nozzle substrate 20 in advance of a specular surface polishing step and a washing step.

Note that the nozzle orifices 21 are opened by pressing the tabular metal member having a length of 30 mm, a width of 15 mm, and a thickness of 0.05 mm.

As the tabular metal member, stainless steel being a representative of iron alloy can be used. Stainless steel means steel in which the content of Cr is 10.5% or higher as described in No. 4201 of JIS G0203:2000. Various types of steel can be used.

Regarding the steel type, for the austenite type, a steel type containing about 10.5 to 35 weight %, preferably, about 11 to 30 weight % of Cr and about 5 to 30 weight % of Ni can be employed. For ferrite type, a steel type containing about 10.5 to 35 weight %, preferably, about 15 to 30 weight % of Cr can be employed. Other examples include steel types defined by JIS G04305:2005 and JIS G4312-1991. Alternatively, a stainless steel can also be used in which other alloy elements are added to such a standard steel type as a base to improve various properties.

As a nickel group alloy, for example, a highly-corrosion-resistant Ni—Cr—Fe alloy containing 12 to 27 weight % of Cr and 5 to 18 weight % of Fe can be used. Such a type of alloy is known as “Inconel alloy”.

The tabular metal member is punched from the discharge face and the opposite face. Burrs caused by punching are removed by polishing or chemical etching.

Next, in the intermediated-layer formation step of (b) of FIG. 6A, the SiO₂ film 31 is formed on the surface of the nozzle substrate 20 by, e.g., a sputtering method. After a tape 60 is attached to the opposite face of the liquid discharge face, the silane-coupling-agent layer 32 is formed on the surface of the SiO₂ film 31 to form the intermediated layer 30.

Here, as the silane-coupling-agent, a coupling agent having amino group is preferable and in particular, 3-Aminopropyltriethoxysilane is preferable. For example, KBE-903 (Shin-Etsu Chemical Co., Ltd.) and A1100 (Momentive Performance Materials Inc.) are usable. The silane-coupling-agent layer 32 can be formed by any of, e.g., dipping method, spin coating method, and spraying method.

For a coupling agent having amino group, the amino group is compatible with ether part of the hetero ring in fluororesin molecule. Accordingly, forming one layer of the silane coupling agent having amino group on the silica layer can significantly enhances the fixing properties of fluororesin.

Then, the film formation step of the liquid-repellent film 40 illustrated in (b) of FIG. 6B is performed to deposit and form a liquid-repellent material on the nozzle substrate 20 according to the vapor deposition method. At this time, the liquid-repellent film 40 is formed on the surface of the silane-coupling-agent layer 32 (the surface of the intermediated layer 30) on the nozzle substrate 20.

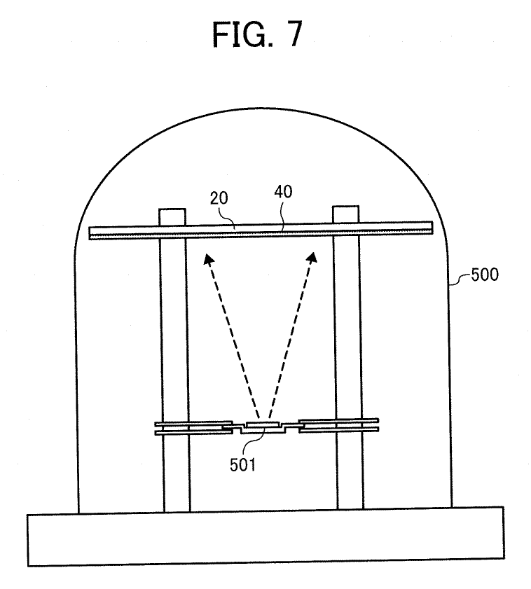

The fluororesin having the fluorine-containing heterocyclic structure with ether linkage in the PTFE skeleton is heated at temperatures of 350° C. to 420° C. in high vacuum of 1.5 to 8.0×10⁻³ Pa and deposited in vacuum so that the thickness of a vapor deposition film on the nozzle substrate 20 corresponding to a vapor deposition source is about 1 to 3 μm. For example, as illustrated in FIG. 7, the vacuum vapor deposition is performed with a vapor deposition source 501 and the nozzle substrate 20 disposed opposite each other in a vacuum chamber 500.

Then, as illustrated in (d) of FIG. 6B, a flattening step is performed by annealing (heat treatment).

Heat treatment (annealing) is performed by baking a film, which is obtained by performing vapor deposition on the nozzle substrate 20 at uncontrolled temperatures without heating, at temperatures equal to or higher than the glass transition temperature Tg of fluororesin.

Baking may be performed by any of, for example, a convection drying oven, a circulation blowing drying oven, a flush annealer, a halogen lump heater, or a vacuum drier, and is preferably performed under nitrogen atmosphere. Baking temperature is preferably higher than the glass transition temperature Tg by 20° C. to 30° C. For example, when the glass transition temperature Tg is 160° C. (Teflon® AF1600), heating is preferably performed by about 180° C.

By baking (annealing) the film at temperatures equal to or higher than the glass transition temperature Tg of fluororesin, a fluororesin film is obtained as the liquid-repellent film 40 that is fine and smooth-surfaced and has the slope region 41 that is smaller in film thickness toward the nozzle 11.

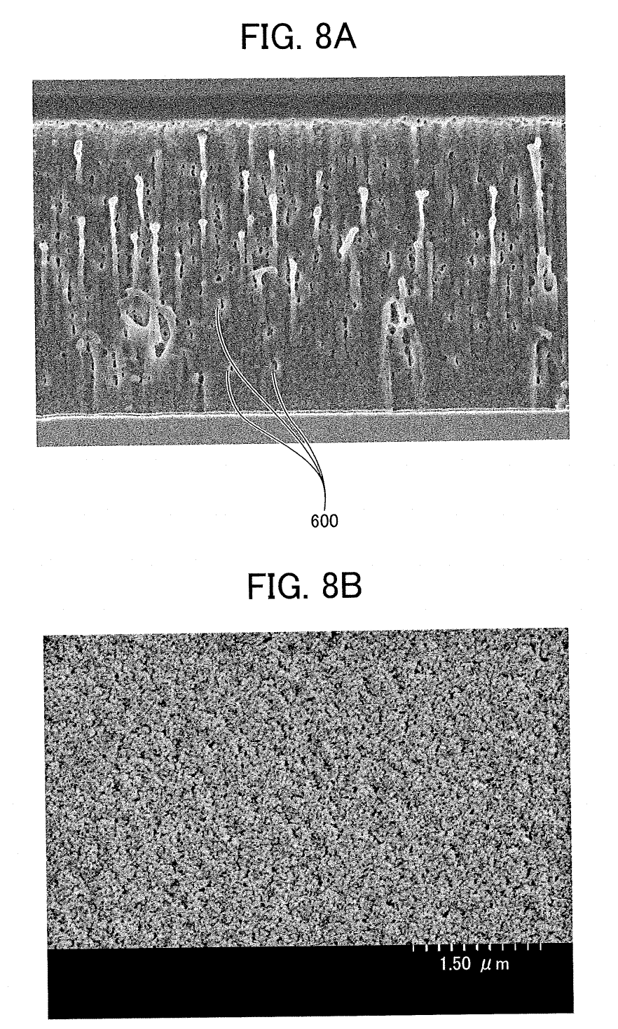

For example, as illustrated in FIG. 8A, before baking, the film includes pores 600. The surface of the film has a contact angle of 114° relative to pure water and an Ra of 8 nm. After baking, as illustrated in FIG. 9A, the film includes few cavities. The surface of the film has a contact angle of 129° relative to pure water and an Ra of 1 nm or smaller.

The surface of the fluororesin film has a tapered shape (sloped shape) within a range of 40 nm from the edge 11a of the nozzle 11 and a flat face outside the range of 40 nm.

Note that, in some embodiments, heat treatment (annealing) may be performed in the vapor deposition step instead of performing heat treatment after the vapor deposition step ((c) of FIG. 6B). By performing vapor deposition on the fluororesin while heating the nozzle substrate 20, the surface of the fluororesin can be smoothed even in the heat treatment at temperatures lower than the glass transition temperature Tg of the fluororesin.

Next, a description is given of the method of film formation in the liquid-repellent film.

As described above, the liquid-repellent film is formed on the nozzle substrate by vapor deposition using the fluororesin having the fluorine-containing heterocyclic structure with ether linkage in the PTFE skeleton. The inventors have found that, unlike a liquid-repellent film obtained by a liquid phase method (for example, dipping), the uppermost surface of the liquid-repellent film thus configured has fine asperities. As described above, the liquid-repellent film also includes pores.

Accordingly, when liquid has a low surface tension like liquid in which surfactant is added, liquid made of organic solvent, the original liquid repellency of fluororesin on the nozzle face may not obtained.

Hence, in the above-described embodiment, by heating the liquid-repellent film after vapor deposition or during vapor deposition, the liquid-repellent film flows. Accordingly, the surface of the liquid-repellent film is smoothed, thus eliminating pores inside the film.

Therefore, when the liquid-repellent film is heated after vapor deposition, heat treatment is performed at temperatures equal to or higher than the glass transition temperature Tg of the fluororesin. By contrast, when the liquid-repellent film is heated at temperatures significantly higher than the glass transition temperature Tg, the film shape obtained at high dimensional accuracy by the gas phase method may be melted and broken. Therefore, after film formation, heat treatment is preferably performed on the liquid-repellent film at temperatures higher than the glass transition temperature Tg by 20° C. to 30° C.

When heat treatment is performed during the vapor deposition step, vapor deposition is performed on the fluororesin while heating the nozzle substrate 20. Accordingly, the liquid-repellent film is heated immediately after the liquid-repellent film is formed on the nozzle substrate 20. Thus, heat treatment can be performed at temperatures lower than the glass transition temperature Tg. In such a case, as the materials of the nozzle substrate and the intermediate layer, materials having relatively low heat resistance can be selected.

Next, a description is given of the glass transition temperature Tg of the fluororesin (liquid-repellent material) forming the liquid-repellent film.

The nozzle plate 1 includes the liquid-repellent film 40 made of the fluororesin having the PTFE skeleton of the fluorine-containing heterocyclic structure with ether linkage. For example, when the nozzle plate 1 is used as a nozzle plate of a liquid discharge head described below, the nozzle plate 1 is bonded to a channel substrate, which includes, e.g., individual liquid chambers communicated with the nozzles 11, with an adhesive.

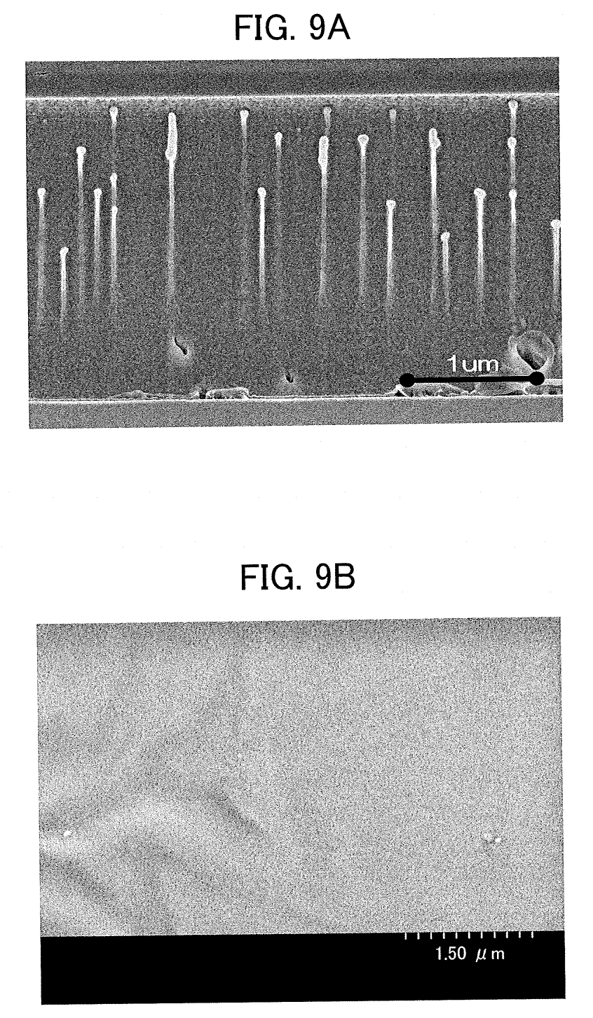

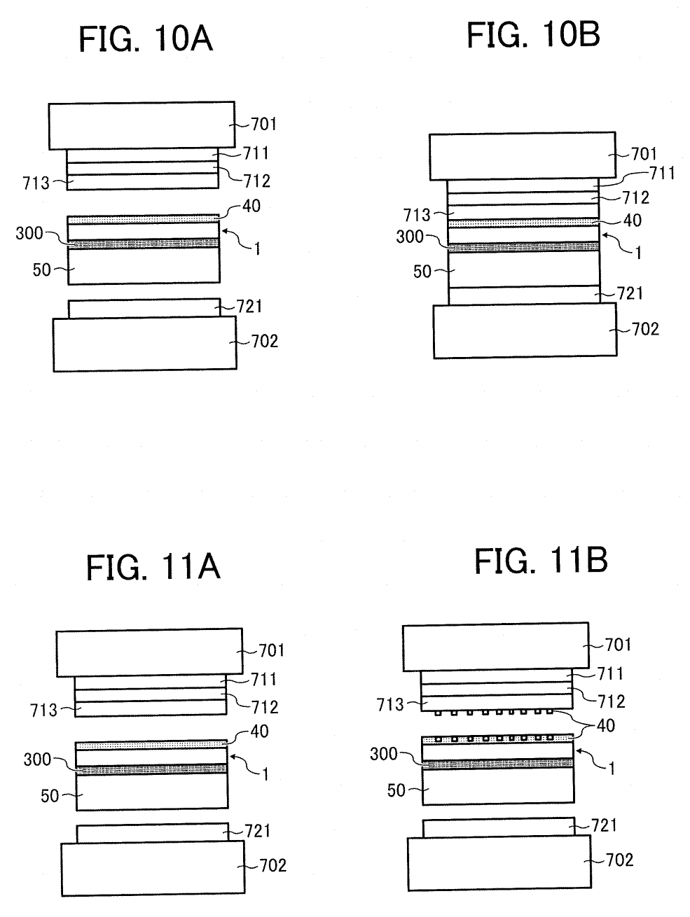

In the bonding step, for example, as illustrated in FIG. 10A, an epoxy thermosetting adhesive 300 is coated on a channel substrate 50. the nozzle plate 1 overlaid on the channel substrate 50 is disposed between the nozzle plate 1 an upper jig 701 and a lower jig 702.

A dummy restrictor 713 is mounted to the upper jig 701 via a silicon sheet 711 and a Teflon® sheet 712. The dummy restrictor 713 contacts the liquid-repellent film 40 of the nozzle plate 1. A dummy restrictor 721 is mounted to the lower jig 702.

As illustrated in FIG. 10B, a bonded member of the nozzle plate 1 and the channel substrate 50 interposed between the dummy restrictor 713 of the upper jig 701 and the dummy restrictor 721 of the lower jig 702 is pressed and heated to cure the adhesive 300.

As bonding conditions, pressure of equal to or greater than 10 kg/cm² and temperatures of equal to or higher than 150° C. are applied for 15 hours or longer to perform bonding, thus obtaining a desired bonding strength.

In the present embodiment, when the glass transition temperature Tg of the liquid-repellent film 40 is equal to or higher than 200° C., as illustrated in FIG. 11A, the liquid-repellent film 40 can be bonded to the dummy restrictor 713 without being transferred to the dummy restrictor 713.

By contrast, when the glass transition temperature Tg of the liquid-repellent film 40 is lower than 200° C., as illustrated in FIG. 11B, the liquid-repellent film 40 may be damaged and transferred to the dummy restrictor 713.

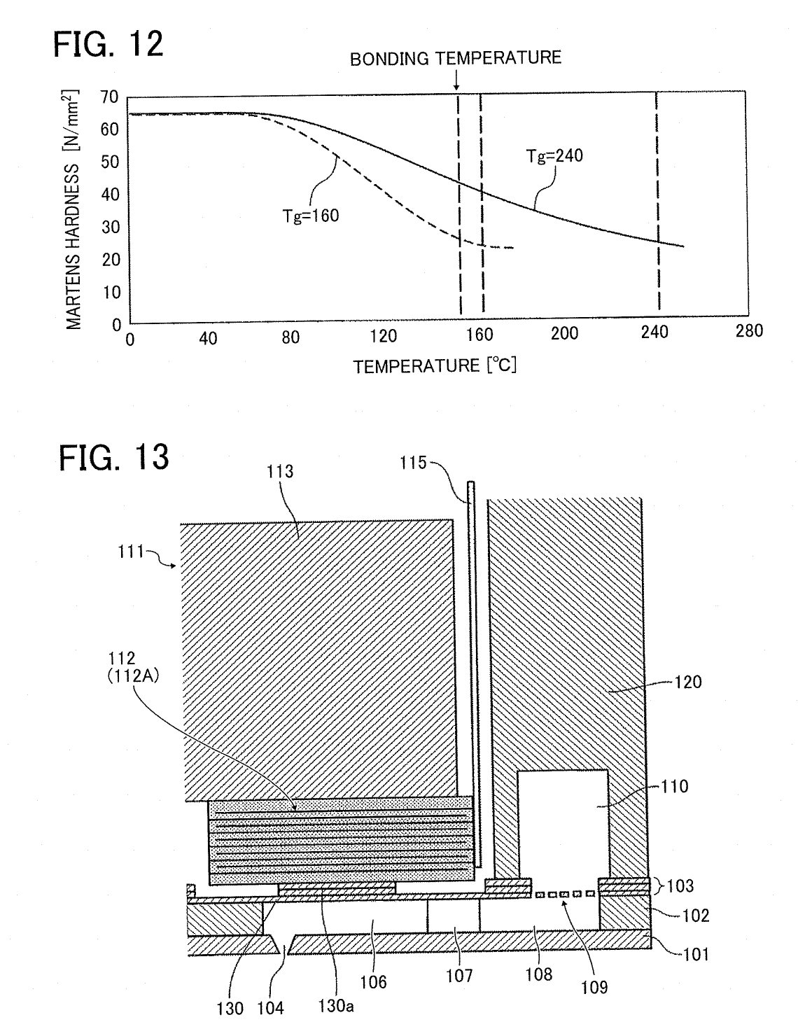

In such a case, for example, when the fluororesin is a thermoplastic resin, such as Teflon® AF, as illustrated in FIG. 12, the hardness may be strikingly lowered by heating. In such a case, it is considered that, due to a molecular weight distribution of resin, a portion of lower molecular weight decreases faster in hardness, in other words, starts flowing earlier. In such a state, if pressure is applied to the liquid-repellent film 40 contacting an opposing member (the dummy restrictor 713), a portion of the liquid-repellent film 40 might be transferred to the opposing member.

In other words, as illustrated in FIG. 12, when the fluororesin has a glass transition temperature Tg of 160° C., the Martens hardness at 150° C. being the bonding temperature is equal to or lower than 25 N/mm². The value of the Martens hardness is considered to indicate a state immediately before the structure as the resin film completely collapses. In such a state, the transfer of the fluororesin to the opposing member is easily caused.

By contrast, when the glass transition temperature Tg of the fluororesin is 240° C., the Martens hardness at 150° C. being the bonding temperature is 40 N/mm². The Martens hardness, though slightly lowered, is considered to indicate that most of the structure as the resin film is maintained. Accordingly, it is considered that the transfer of the fluororesin to the opposing member does not occur even under the above-described bonding conditions.

Hence, by using, as the liquid-repellent film 40b, the fluororesin having a glass transition temperature equal to or higher than 200° C. and having the PTFE skeleton of the fluorine-containing heterocyclic structure with ether linkage, the nozzle plate and another member can be stably bonded together with high quality.

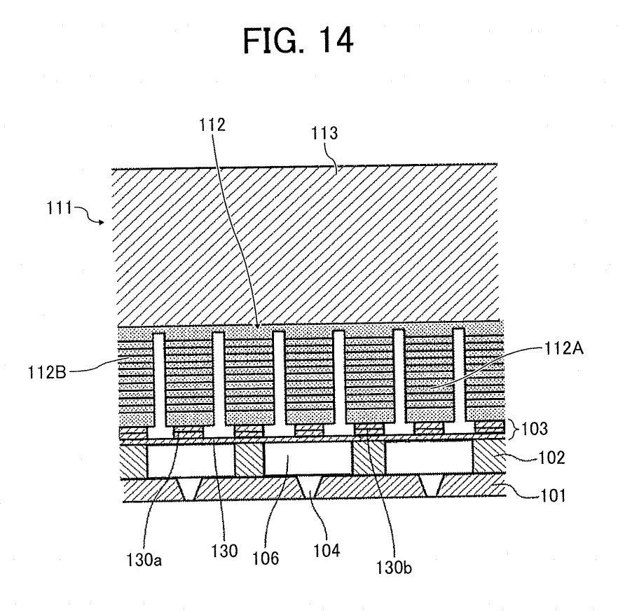

Next, a liquid discharge head according to an embodiment of the present disclosure is described with reference to FIGS. 13 and 14. FIG. 3 is a cross section of the liquid discharge head in a direction (liquid-chamber longitudinal direction) perpendicular to a nozzle array direction in which the nozzles are arrayed in row. FIG. 14 is a cross-sectional view of the liquid discharge head in the nozzle array direction (liquid-chamber transverse direction).

A liquid discharge head 404 according to the present embodiment includes a nozzle plate 101, a channel plate 102, and a diaphragm member 103 being a thin-film member as a wall member that are laminated one on another and bonded to each other. The liquid discharge head 404 includes piezoelectric actuators 111 to displace the diaphragm member 3 and a frame member 120 as a common-liquid-chamber substrate.

The nozzle plate 101, the channel plate 102, and the diaphragm member 103 constitute the individual liquid chambers 106 communicated with a plurality of nozzles 104 to discharge liquid, the fluid restrictors 107 to supply liquid to the individual liquid chambers 106, and liquid introduction portions 108 communicated with the fluid restrictors 107.

Liquid is supplied from a common liquid chamber 110 as a common channel of the frame member 120 to each individual liquid chamber 106 through a supply-port filter 109, the liquid introduction portion 108, and the fluid restrictor 107. The filters 109 are formed in the diaphragm member 103. A filter may be provided to the liquid introduction portion 108.

The diaphragm member 103 is a wall member forming walls of the individual liquid chambers 106 of the channel plate 102. The diaphragm member 103 has a three-layer structure. Deformable vibration portions (diaphragms) 130 are formed with a single layer facing the channel plate 102 at positions corresponding to the individual liquid chambers 106.

The piezoelectric actuators 111 including electromechanical transducer elements as driving devices (actuator devices or pressure generators) to deform the vibration portions 130 of the diaphragm member 103 are disposed at a first side of the diaphragm member 103 opposite a second side facing the individual liquid chambers 106.

The piezoelectric actuator 111 includes a plurality of lamination-type piezoelectric members 112 bonded to a base member 113 with adhesive. The lamination-type piezoelectric member 112 is grooved by half cut dicing, and a predetermined number of piezoelectric elements (piezoelectric pillars) 112A and 112B having a pillar shape are formed at predetermined intervals in a comb shape on the lamination-type piezoelectric member 112.

Although the piezoelectric elements 112A and 112B of the piezoelectric member 112 are the same, the piezoelectric element 112A is driven by applying a drive waveform and the piezoelectric element 112B is not driven by a drive waveform and is simply used as a pillar.

The piezoelectric elements 112A are bonded to projections 103a being island-shaped thick portions in the vibration portions 130 of the diaphragm member 103. The piezoelectric elements 112B are bonded to projections 30b being thick portions of the diaphragm member 3.

The piezoelectric member 112 includes piezoelectric layers and internal electrodes alternately laminated one on another. The internal electrodes are led out to end faces to form external electrodes. The flexible printed circuit (FPC) 115 as a flexible wiring member is connected to external electrodes of the piezoelectric element 112A to apply a drive signal to the piezoelectric element 112A.

The frame member 120 is manufactured by injection molding with, for example, an epoxy-based resin or polyphenylene sulfite as a thermoplastic resin and includes the common liquid chamber 110 where the liquid is supplied from a head tank or a liquid cartridge.

In the liquid discharge head 404, for example, when the voltage applied to the piezoelectric element 112A is lowered from a reference potential, the piezoelectric element 112A contracts. As a result, the vibration portion 130 of the diaphragm member 103 is pulled and the volume of the individual liquid chamber 106 increases, thus causing liquid to flow into the individual liquid chamber 106.

When the voltage applied to the piezoelectric element 112A is raised, the piezoelectric element 112A expands in the direction of lamination. The vibration portion 130 of the diaphragm member 103 deforms in a direction toward the nozzle 104 and contracts the volume of the individual liquid chamber 106. Thus, liquid in the individual liquid chamber 106 is pressurized and discharged (jetted) from the nozzle 104.

When the voltage applied to the piezoelectric element 112A is returned to the reference voltage, the vibration portion 130 of the diaphragm member 103 is returned to the initial position so that the individual liquid chamber 106 inflates, which generates a negative pressure. Thus, the liquid is supplied from the common liquid chamber 110 to the individual liquid chamber 106. After vibration of a meniscus surface of the nozzle 104 decays to a stable state, the process shifts to an operation for the next droplet ejection.

Note that the driving method of the liquid discharge head is not limited to the above-described example (pull-push discharge). For example, pull discharge or push discharge may be performed in response to the way to apply the drive waveform.

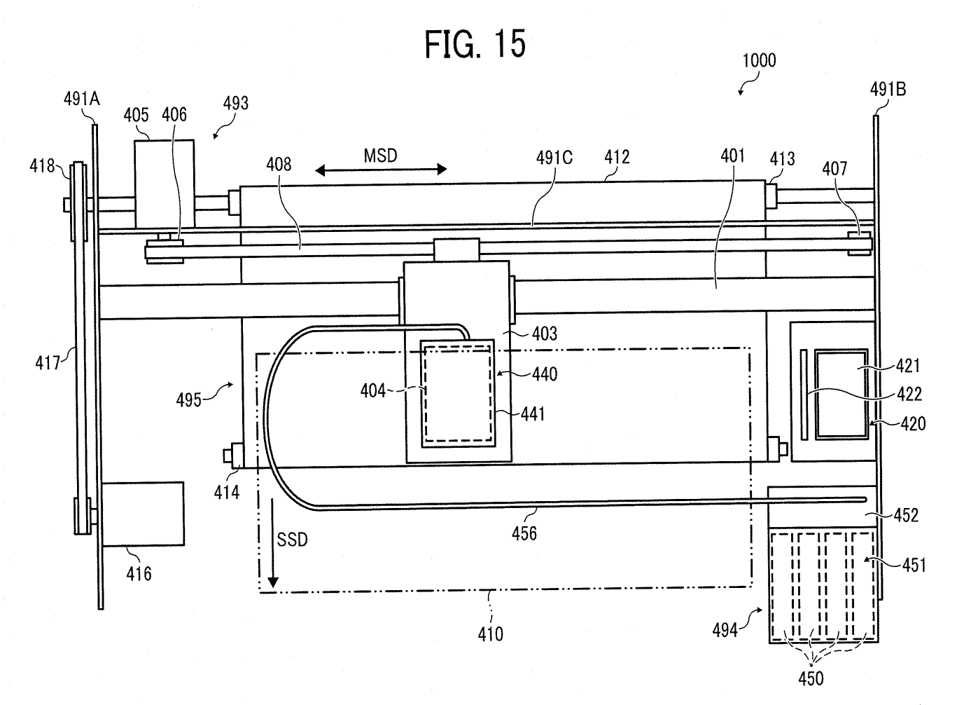

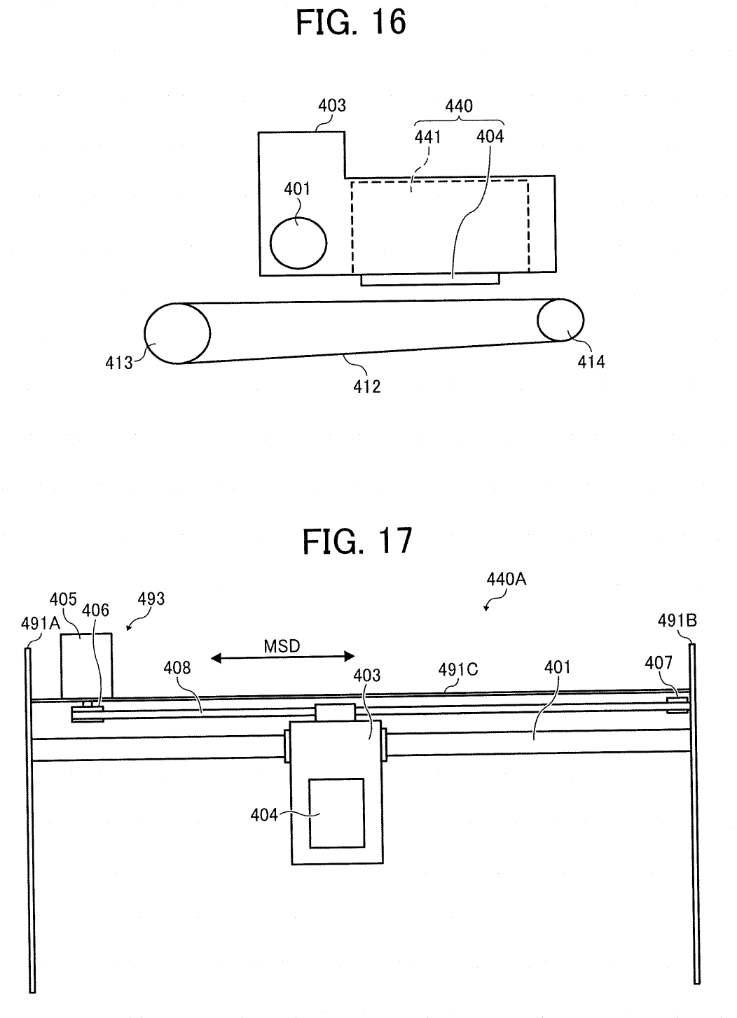

Next, a liquid discharge apparatus according to an embodiment of the present disclosure is described with reference to FIGS. 15 and 16. FIG. 15 is a plan view of a portion of the liquid discharge apparatus according to an embodiment of the present disclosure. FIG. 16 is a side view of a portion of the liquid discharge apparatus of FIG. 15.

A liquid discharge apparatus 1000 according to the present embodiment is a serial-type apparatus in which a main scan moving unit 493 reciprocally moves a carriage 403 in a main scanning direction indicated by arrow MSD in FIG. 15. The main scan moving unit 493 includes, e.g., a guide 401, a main scanning motor 405, and a timing belt 408. The guide 401 is laterally bridged between a left side plate 491A and a right side plate 491B and supports the carriage 403 so that the carriage 403 is movable along the guide 401. The main scanning motor 405 reciprocally moves the carriage 403 in the main scanning direction MSD via the timing belt 408 laterally bridged between a drive pulley 406 and a driven pulley 407.

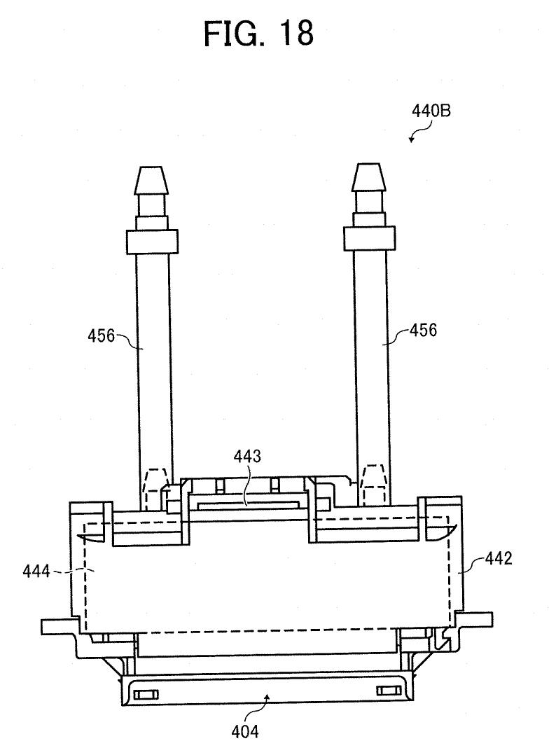

The carriage 403 mounts a liquid discharge device 440 in which the liquid discharge head 404 and a head tank 441 are integrated as a single unit. The liquid discharge head 404 of the liquid discharge device 440 discharges ink droplets of respective colors of yellow (Y), cyan (C), magenta (M), and black (K). The liquid discharge head 404 includes nozzle rows, each including a plurality of nozzles arrayed in row in a sub-scanning direction, which is indicated by arrow SSD in FIG. 18, perpendicular to the main scanning direction MSD. The liquid discharge head 404 is mounted to the carriage 403 so that ink droplets are discharged downward.

The liquid stored outside the liquid discharge head 404 is supplied to the liquid discharge head 404 via a supply unit 494 that supplies the liquid from a liquid cartridge 450 to the head tank 441.

The supply unit 494 includes, e.g., a cartridge holder 451 as a mount part to mount liquid cartridges 450, a tube 456, and a liquid feed unit 452 including a liquid feed pump. The liquid cartridge 450 is detachably attached to the cartridge holder 451. The liquid is supplied to the head tank 441 by the liquid feed unit 452 via the tube 456 from the liquid cartridges 450.

The liquid discharge apparatus 1000 includes a conveyance unit 495 to convey a sheet 410. The conveyance unit 495 includes a conveyance belt 412 as a conveyor and a sub-scanning motor 416 to drive the conveyance belt 412.

The conveyance belt 412 electrostatically attracts the sheet 410 and conveys the sheet 410 at a position facing the liquid discharge head 404. The conveyance belt 412 is an endless belt and is stretched between a conveyance roller 413 and a tension roller 414. The sheet 410 is attracted to the conveyance belt 412 by electrostatic force or air aspiration.

The conveyance roller 413 is driven and rotated by the sub-scanning motor 416 via a timing belt 417 and a timing pulley 418, so that the conveyance belt 412 circulates in the sub-scanning direction SSD.

At one side in the main scanning direction MSD of the carriage 403, a maintenance unit 420 to maintain and recover the liquid discharge head 404 in good condition is disposed on a lateral side of the conveyance belt 412.

The maintenance unit 420 includes, for example, a cap 421 to cap a nozzle face (i.e., a face on which the nozzles are formed) of the liquid discharge head 404 and a wiper 422 to wipe the nozzle face.

The main scan moving unit 493, the supply unit 494, the maintenance unit 420, and the conveyance unit 495 are mounted to a housing that includes the left side plate 491A, the right side plate 491B, and a rear side plate 491C.

In the liquid discharge apparatus 1000 thus configured, the sheet 410 is conveyed on and attracted to the conveyance belt 412 and is conveyed in the sub-scanning direction SSD by the cyclic rotation of the conveyance belt 412.

The liquid discharge head 404 is driven in response to image signals while the carriage 403 moves in the main scanning direction MSD, to discharge liquid to the sheet 410 stopped, thus forming an image on the sheet 410.

As described above, the liquid discharge apparatus 1000 includes the liquid discharge head 404 according to an embodiment of the present disclosure, thus allowing stable formation of high quality images.

Next, another example of the liquid discharge device according to an embodiment of the present disclosure is described with reference to FIG. 17. FIG. 17 is a plan view of a portion of another example of the liquid discharge device (liquid discharge device 440A).

The liquid discharge device 440A includes the housing, the main scan moving unit 493, the carriage 403, and the liquid discharge head 404 among components of the liquid discharge apparatus 1000. The left side plate 491A, the right side plate 491B, and the rear side plate 491C constitute the housing.

Note that, in the liquid discharge device 440A, at least one of the maintenance unit 420 and the supply unit 494 may be mounted on, for example, the right side plate 491B.

Next, another example of the liquid discharge device according to an embodiment of the present disclosure is described with reference to FIG. 18. FIG. 18 is a front view of still another example of the liquid discharge device (liquid discharge device 440B).

The liquid discharge device 440B includes the liquid discharge head 404 to which a channel part 444 is mounted, and the tube 456 connected to the channel part 444.

Further, the channel part 444 is disposed inside a cover 442. Instead of the channel part 444, the liquid discharge device 440B may include the head tank 441. A connector 443 to electrically connect the liquid discharge head 404 to a power source is disposed above the channel part 444.

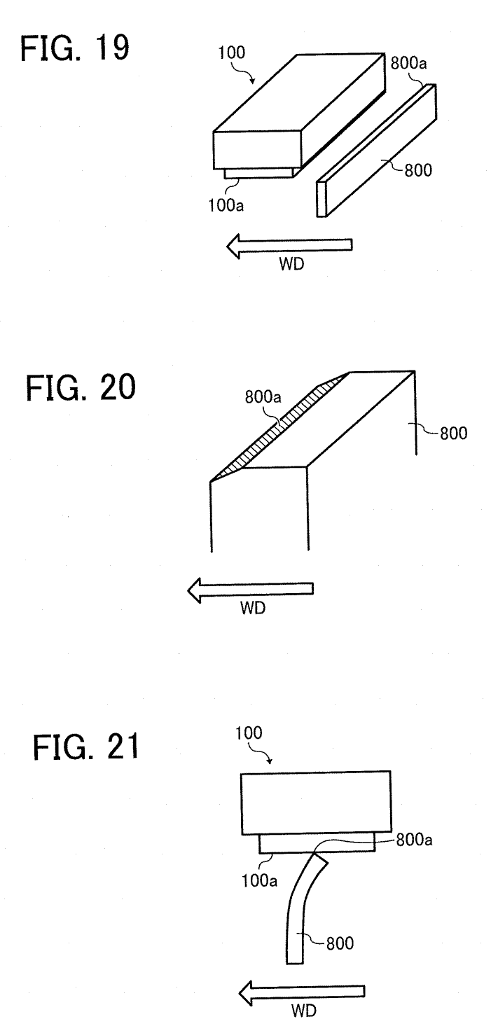

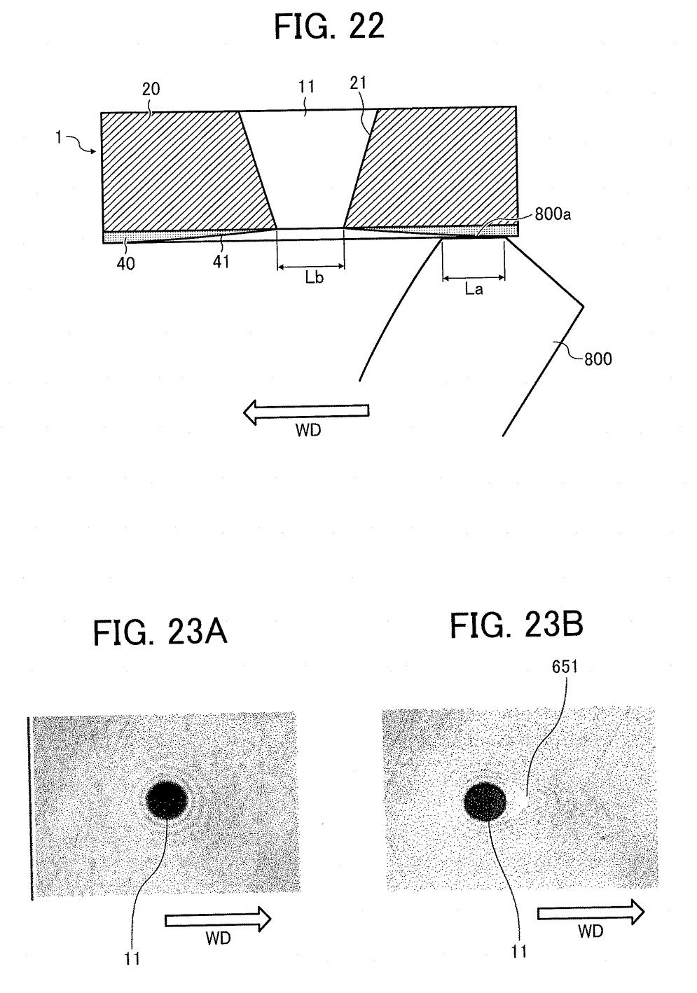

Next, a wiper in a third embodiment of the present disclosure is described with reference to FIGS. 19 to 22. FIG. 19 is a perspective view of a liquid discharge head and the wiper in the third embodiment of the present disclosure. FIG. 20 is an enlarged perspective view of a leading end of the wiper. FIG. 21 is a side view of the liquid discharge head and the wiper in a wiping state. FIG. 22 is an enlarged view of a nozzle plate and the leading end of the wiper of FIG. 21 in the wiping state.

First, a description is given of wiping resistance (wiping endurance) when the fluororesin having the PTFE skeleton of the fluorine-containing heterocyclic structure with ether linkage is used in the liquid-repellent film.

Since the fluororesin having the PTFE skeleton of the fluorine-containing heterocyclic structure with ether linkage used in the above-described embodiment is hard and brittle, film scraping is likely to be caused by wiping of the wiper and the wiping resistance may be low. In particular, film scraping is more likely to be caused in an area downstream from an edge portion of a nozzle (nozzle orifice).

Hence, in the above-described embodiment, the liquid-repellent film includes the slope region that slopes in a direction in which the film thickness is smaller toward an edge of a nozzle in the peripheral portion of the nozzle and thus the edge portion of the nozzle has a sloped shape in a direction away from the wiper. With such a configuration, in wiping, the wiper is supported by an outer face of the nozzle than the slope region, thus preventing the wiper from entering the nozzle. In addition, the interference of the wiper with the edge portion of the nozzle can be reduced and the scraping of the liquid-repellent film can be prevented, thus enhancing the wiping resistance.

However, depending on the type of liquid to be discharged or the way of pressing the wiper to the nozzle face, wiping resistance may be insufficient only by providing the slope region that slopes in a direction in which the film thickness is smaller toward an edge of a nozzle in the peripheral portion of the nozzle as in the above-described embodiment. Consequently, wearing may occur in the edge portion of the nozzle.

Hence, in the present embodiment, wiping is performed with the wiper face-contacting the nozzle face. Such a configuration can prevent a contact portion of the wiper with face of a nozzle plate from excessively contacting the interior of the nozzle and scraping the liquid-repellent film at the slope region.

In other words, as illustrated in FIGS. 20 to 22, at a contact portion (leading portion) to contact the nozzle face 100a (the uppermost surface of the liquid-repellent film 40) of the liquid discharge head 100, a wiper (wiper member) 800 has, in a cross section along a wiping direction WD, a shape in which a contact face 800a face-contacts the nozzle face 100a at a predetermined width La when the wiper contacts and wipes the nozzle face 100a.

In the present embodiment, the width La of the contact face 800a of the wiper 800, at which the wiper 800 contacts and wipes the nozzle face 100a, is greater than an opening width Lb (in the present embodiment, the nozzle diameter) of the nozzle 11 in the wiping direction WD.

In wiping, the wiper 800 relatively moves in the wiping direction WD with the contact face 800a face-contacting the nozzle face 100a.

The above-described shape of the leading end contacting the nozzle face 100a of the wiper 800, in combination with the slope region 41 around the edge portion of the nozzle 11, prevents the leading end of the wiper 800 face-contacting the nozzle face 100a from entering the interior of the nozzle 11. Thus, forming the contact face 800a at the leading end of the wiper 800 contacting the nozzle face 100a reduces the elastic deformation amount of the wiper 800, thus reducing entry of the wiper 800 into the nozzle 11.

Accordingly, wearing of the edge portion of the nozzle can be reduced.

In other words, when the contact portion of the wiper 800 has an edged shape, as illustrated in FIG. 23B, insufficient wiping resistance may cause scraping 651 due to wearing in the wiping direction WD outside the edge portion of the nozzle 11, depending on the way of pressing the wiper 800 onto the nozzle face 100a or the type of liquid to be wiped.

By contrast, when the contact portion of the wiper 800 has the shape to face-contact the nozzle face 100a at the predetermined width, as illustrated in FIG. 23A, wearing of the edge portion of the nozzle 11 can be reduced even in a condition (the way of pressing the wiper 800 or the type of liquid to be wiped) in which wearing occurs when the contact portion has the edged shape.

A maintenance unit including the wiper in the third embodiment may be integrated with a liquid discharge head to form the above-described liquid discharge device. A maintenance unit of the liquid discharge apparatus may include the wiper in the third embodiment. For the above-described liquid discharge apparatus 1000 illustrated in FIG. 15, the wiping direction of the wiper 422 is the direction perpendicular to the nozzle array direction. However, in the above-described third embodiment, the wiping direction of the wiper 800 is the nozzle array direction.

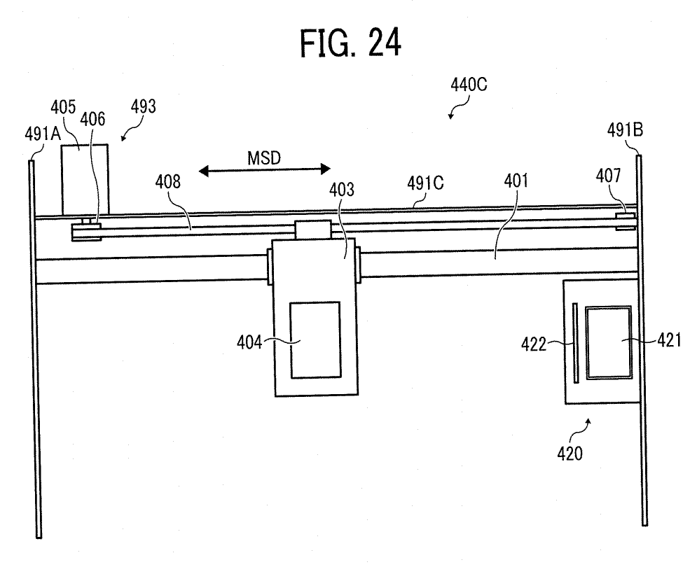

Here, an example of the liquid discharge device including the maintenance unit with the wiper in the above-described third embodiment is described with reference to FIG. 24. FIG. 24 is a plan view of the liquid discharge device C.

The liquid discharge device 440C includes the housing, the main scan moving unit 493, the carriage 403, the liquid discharge head 404, and the above-described maintenance unit 420 among components of the liquid discharge apparatus 1000. The left side plate 491A, the right side plate 491B, and the rear side plate 491C constitute the housing. The maintenance unit 420 is mounted to, for example, the right side plate 491B.

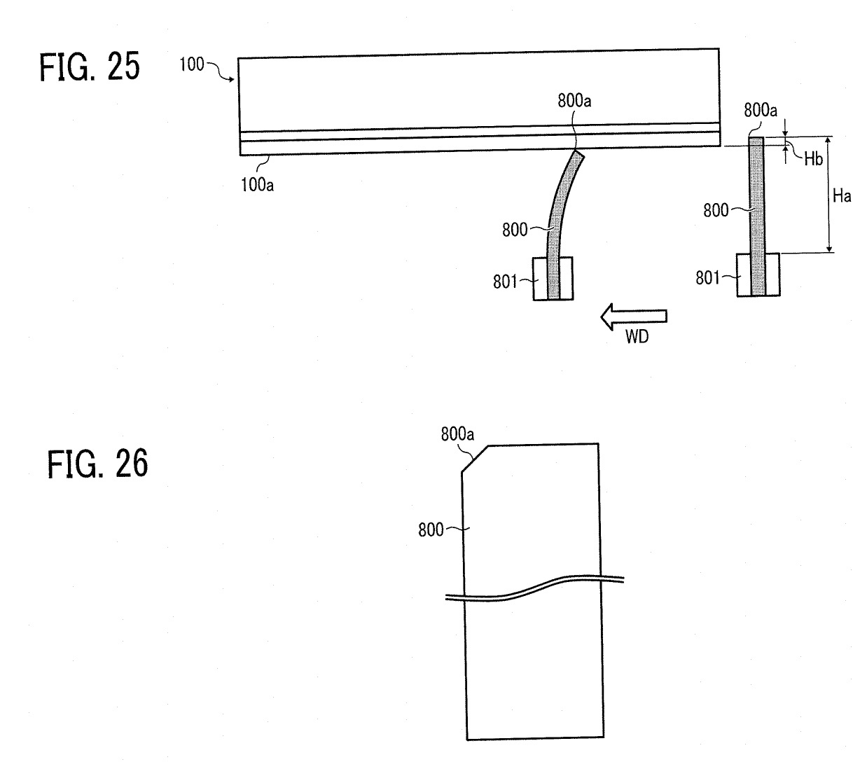

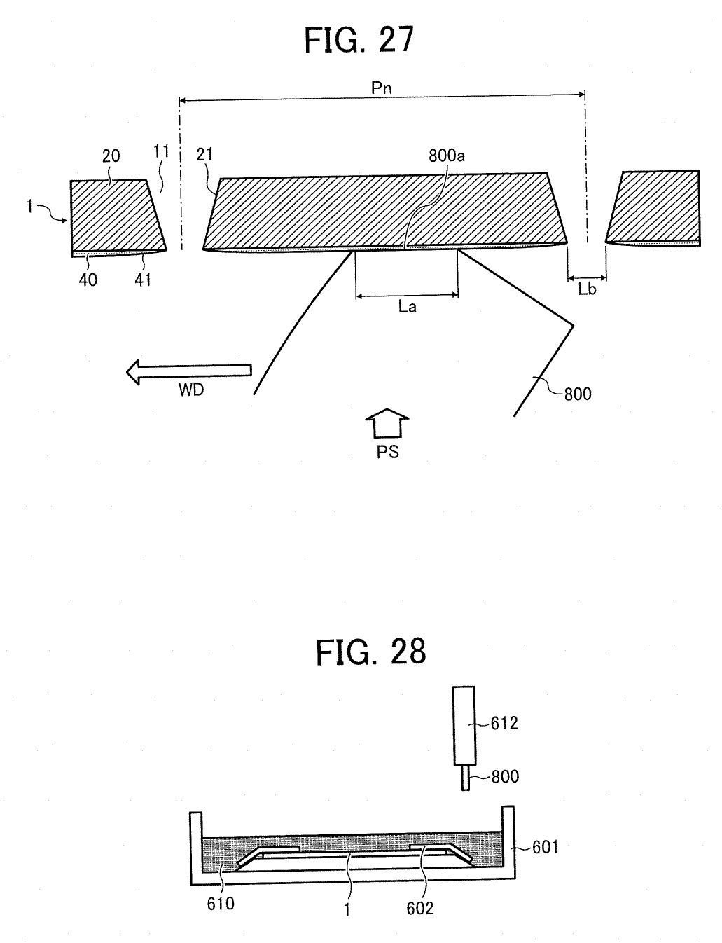

Next, an example of the third embodiment of the present disclosure is described with reference to FIGS. 25 to 27. FIG. 25 is an illustration of a deformable portion and positions of the wiper. FIG. 26 is an illustration of the contact face of the wiper. FIG. 27 is an enlarged view of the wiping of the wiper, the inter-nozzle distance, and the width of the contact face.

As illustrated in FIG. 26, the wiper (wiper blade) 800 having a blade shape of a predetermined thickness has a cutout portion (C chamfer plane) as the contact face 800a at an edge portion of the wiper 800. Note that the wiper 800 is made of ethylene-propylene-diene monomer (EPDM) rubber having a thickness of, e.g., 1 mm.

As illustrated in FIG. 25, the wiper 800 is held by a wiper holder 801. A deformable portion of the wiper 800 has a length Ha from the leading end. The wiper 800 performs wiping operation at a position at which the wiper 800 overlaps the nozzle plate 1 by a predetermined length Hb. Note that, for example, the length Ha is 7 mm and the length Hb is 2 mm.

As illustrated in FIG. 27, in wiping operation, the wiper 800 is bent and the contact face 800a being the C chamfer plane wipes the nozzle face 100a while face-contacting the nozzle face 100a at a predetermined pressure PS.

Note that, in the present embodiment, as illustrated in FIG. 27, the inter-nozzle distance (nozzle pitch) Pn in the wiping direction WD in which the wiper 800 wipes the nozzle 11 is, for example, 100 μm.

<Evaluation of Wiping Resistance>

Wiping resistance (endurance) was evaluated using an evaluation device illustrated in FIG. 28. For example, the nozzle plate 1 is fixed in a container 601 containing ink 610 with a fixing jig 602. The wiper 800 is fixed to a fixing jig 612. Thus, wiping operation is performed on the surface of the liquid-repellent film 40 of the nozzle plate 1.

As the ink 610, GX cartridge black GC21K, which is inkjet ink for RICOH GX-3000 manufactured by RICOH Co. Ltd.

<Evaluation of the Shape of Contact Portion of Wiper with Nozzle Face>

The 3D-measurement laser microscope OLS4100 manufactured by Olympus Corporation was used to measure the width of a flat area at a magnification of 3000 times.

<Observation Method and Rank of Wearing State of Edge after Evaluation of Wiping Resistance>

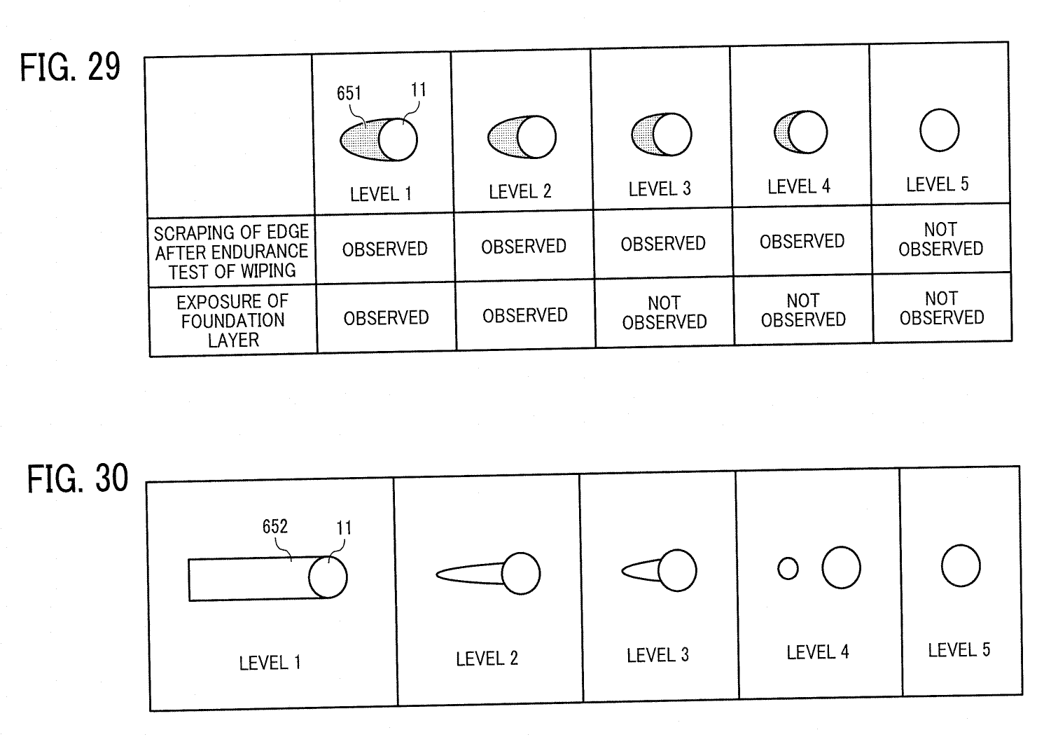

As illustrated in FIG. 29, the length of the scraping 651 from the edge portion of the liquid-repellent film after the evaluation of wiping resistance can be enlarged and observed at a magnification of 1000 times by a metal microscope. As illustrated in FIG. 29, levels 1 to 5 were ranked based on the presence or absence and length of the scraping 651.

<Observation Method and Rank of Ink Adhering to Area Downstream from Nozzle in Wiping Direction after Evaluation of Wiping Resistance>

As illustrated in FIG. 30, streaks 652 of ink adhering to an area downstream from the nozzle 11 in the wiping direction after the evaluation of wiping resistance can be enlarged and observed at a magnification of 1000 times by a metal microscope. As illustrated in FIG. 30, levels 1 to 5 were ranked based on the adhering state (the presence or absence and length) of the streaks 652.

<Evaluation of Jetting Deflection>

A liquid discharge head having the nozzle plate 1 was mounted on IPSIO G515 manufactured by RICOH CO. Ltd. and the jetting deflection was evaluated. In the evaluation, before the wiping resistance test was performed (before resistance test) and after the wiping resistance test was performed 10,000 times, a nozzle check pattern was printed. The printed nozzle check pattern was observed by eyes to evaluate the presence or absence of jetting deflection.

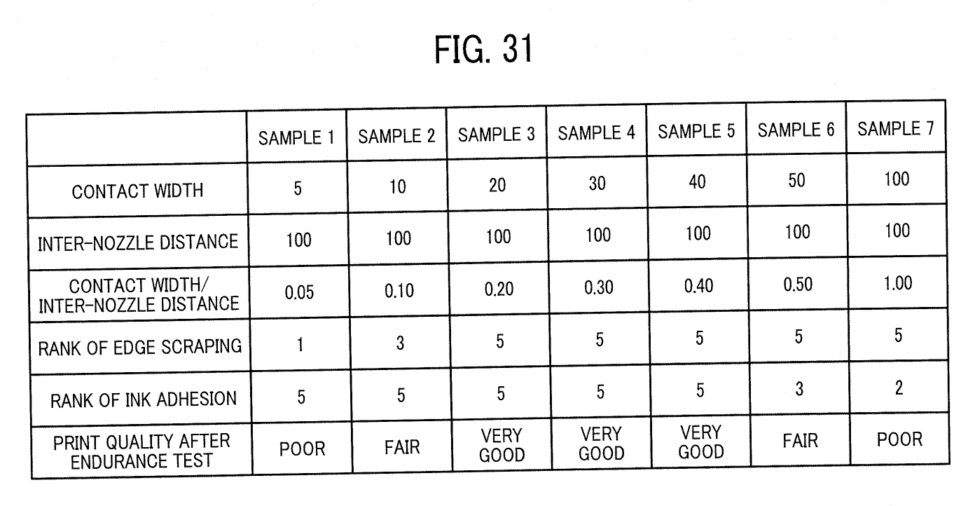

In the present embodiment, as illustrated in FIG. 31, the contact width La of the contact face 800a of the wiper 800 with the nozzle plate 1 was evaluated with seven examples (referred to as Samples 1 through 7) of 5, 10, 20, 30, 40, 50, and 100 μm. Evaluation results are illustrated in FIG. 31.

Note that, regarding the item “print quality after endurance test” (print quality after wiping resistance test) in the table of the evaluation results illustrated in FIG. 31, the term “fair” indicates that the print quality is not problematic in actual use and the term “poor” indicates that the level of jetting deflection is problematic in actual use. The term “good” indicates the jetting deflection is less than the term “fair”. The term “very good” indicates the jetting deflection is less than the term “good”.

From the evaluation results, in Samples 3 through 7 in which the width (contact width) La of the contact face 800a of the wiper 800 is equal to or greater than the opening width (diameter) Lb of the nozzle 11 (i.e., equal to or greater than 20 μm), the scraping of the liquid-repellent film 40 near the edge portion of the nozzle 11 can be reduced. By contrast, in Samples 1 and 2 in which the width La of the contact face 800a of the wiper 800 is smaller than the opening width (diameter) Lb of the nozzle 11, the scraping of the liquid-repellent film 40 at the edge portion occurs.

When the width La is smaller than the inter-nozzle distance (nozzle pitch) Pn (100 μm) between adjacent nozzles, drawing of ink from the nozzles 11 can be reduced. When the contact width La is equal to the inter-nozzle distance Pn (100 μm) between adjacent nozzles, ink streaks 652 drawn from the nozzles 11 were observed in an area downstream from the nozzles 11 in the wiping direction.

In particular, when the nozzle diameter (the opening width Lb) is 20 μm, the inter-nozzle distance Pn is 100 μm, and the contact width La is in a range of from 20 to 40 μm, excellent results are obtained that the scraping 651 of the liquid-repellent film 40 near the edge portion of the nozzle 11 was not observed and the streaks 652 due to drawing of ink were not observed. In other words, when the value obtained by dividing the contact width by the inter-nozzle distance is in a range of 0.2 or greater to 0.4 or smaller, excellent results are obtained.

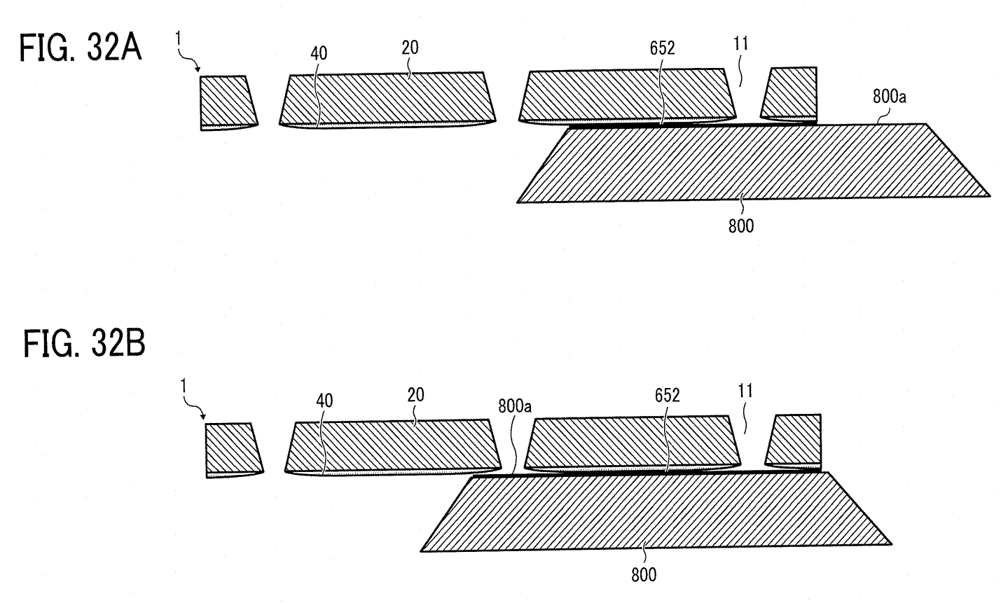

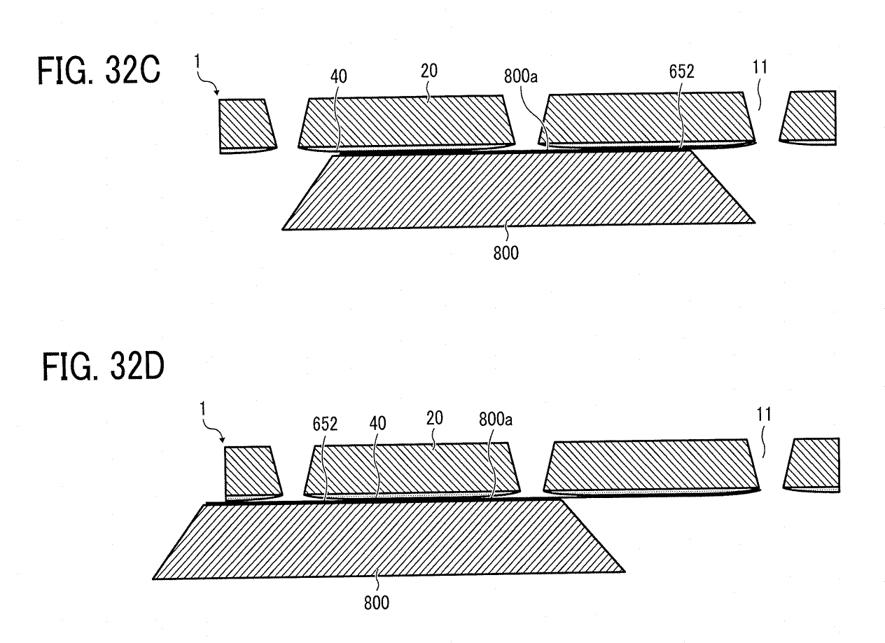

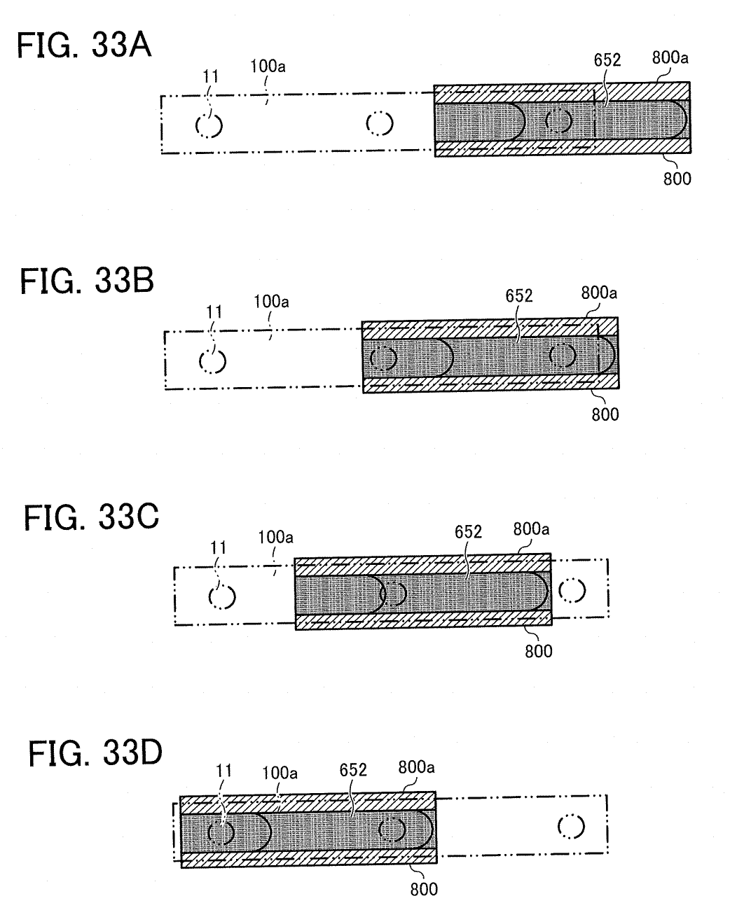

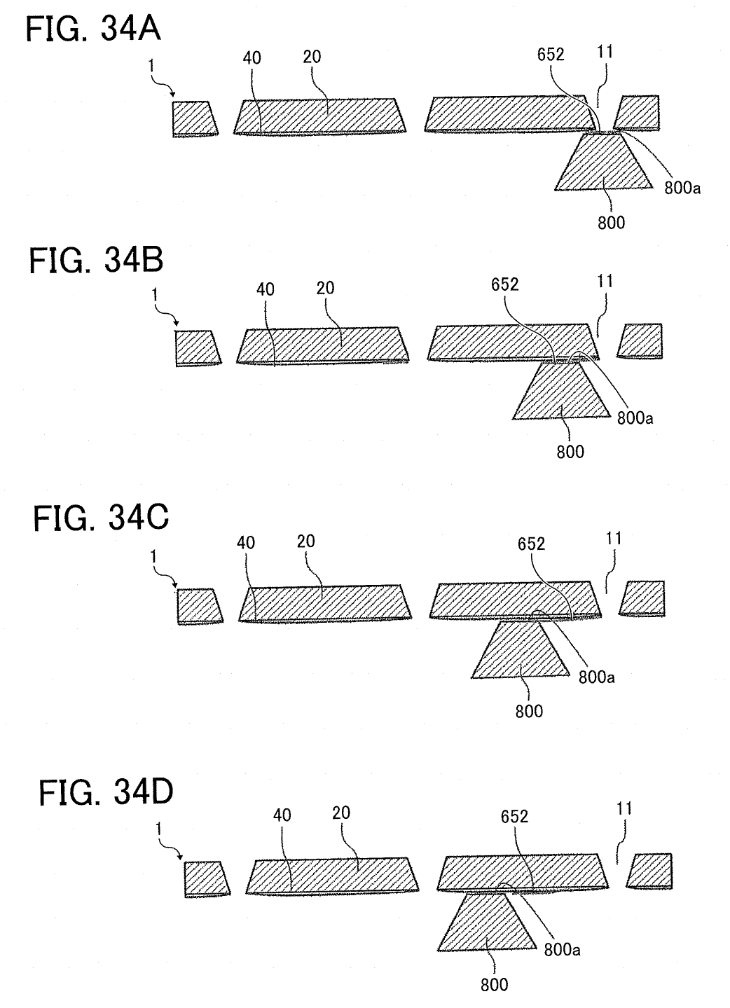

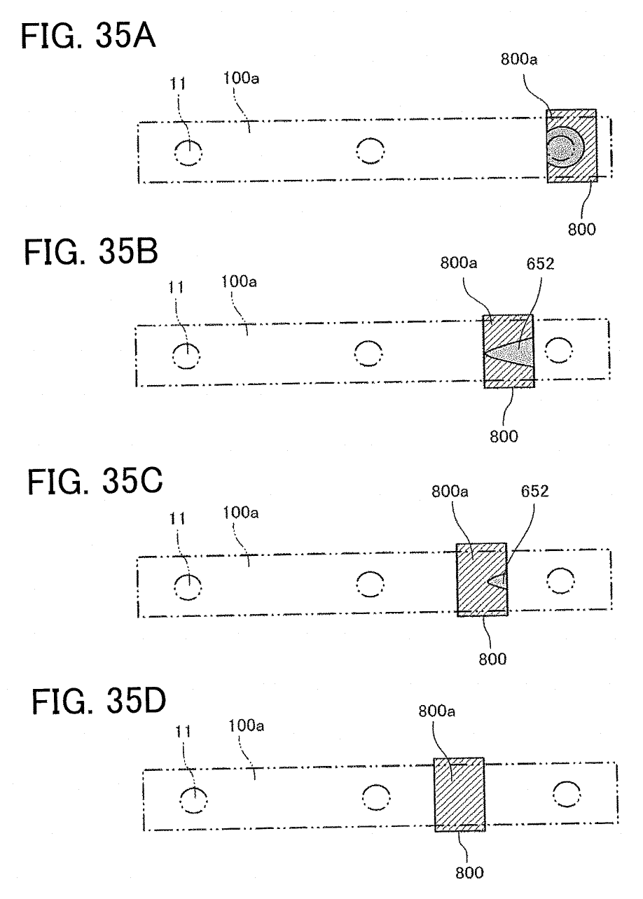

In the present embodiment, the relationship between the width La of the contact face of the wiper and the inter-nozzle distance Pn is described with reference to FIGS. 32A to 35D. FIGS. 32A to 32D are side views of a configuration in which the width La of the contact face is longer than the inter-nozzle distance Pn. FIGS. 33A to 33D are plan views of a wiping face of the wiper. FIGS. 34A to 34D are side views of a configuration in which the width La of the contact face is shorter than the inter-nozzle distance Pn. FIGS. 35A to 35D are plan views of a wiping face of the wiper.

When the width La of the contact face 800a of the wiper 800 is longer than the inter-nozzle distance Pn, as illustrated in FIGS. 32A through 33D, the wiper 800 performs wiping while opposing two adjacent nozzles 11 over the adjacent nozzles 11. Accordingly, the wiper 800 wipes the following nozzle 11 while drawing ink from the preceding nozzle 11. Drawn ink is not interrupted.

By contrast, when the width La of the contact face 800a of the wiper 800 is shorter than the inter-nozzle distance Pn, as illustrated in FIGS. 34A through 34D, the wiper 800 performs wiping without opposing two adjacent nozzles 11 over the adjacent nozzles 11. Accordingly, when the wiper 800 wipes the following nozzle 11, ink drawn from the preceding nozzle 11 is separated, thus preventing ink from being drawn over two adjacent nozzles.

Therefore, the width La of the contact face 800a of the wiper 800 is preferably shorter than the inter-nozzle distance Pn.

In the present disclosure, discharged liquid is not limited to a particular liquid as long as the liquid has a viscosity or surface tension to be discharged from a head. However, preferably, the viscosity of the liquid is not greater than 30 mPa·s under ordinary temperature and ordinary pressure or by heating or cooling. Examples of the liquid include a solution, a suspension, or an emulsion including, for example, a solvent, such as water or an organic solvent, a colorant, such as dye or pigment, a functional material, such as a polymerizable compound, a resin, a surfactant, a biocompatible material, such as DNA, amino acid, protein, or calcium, and an edible material, such as a natural colorant. Such a solution, a suspension, or an emulsion can be used for, e.g., inkjet ink, surface treatment solution, a liquid for forming components of electronic element or light-emitting element or a resist pattern of electronic circuit, or a material solution for three-dimensional fabrication.

Examples of an energy source for generating energy to discharge liquid include a piezoelectric actuator (a laminated piezoelectric element or a thin-film piezoelectric element), a thermal actuator that employs a thermoelectric conversion element, such as a thermal resistor, and an electrostatic actuator including a diaphragm and opposed electrodes.

The liquid discharge device is an integrated unit including the liquid discharge head and a functional part(s) or unit(s), and is an assembly of parts relating to liquid discharge. For example, the liquid discharge device may be a combination of the liquid discharge head with at least one of the head tank, the carriage, the supply unit, the maintenance unit, and the main scan moving unit.

Here, examples of the integrated unit include a combination in which the liquid discharge head and a functional part(s) are secured to each other through, e.g., fastening, bonding, or engaging, and a combination in which one of the liquid discharge head and a functional part(s) is movably held by another. The liquid discharge head may be detachably attached to the functional part(s) or unit(s) s each other.

For example, the liquid discharge head and a head tank are integrated as the liquid discharge device. The liquid discharge head and the head tank may be connected each other via, e.g., a tube to integrally form the liquid discharge device. Here, a unit including a filter may further be added to a portion between the head tank and the liquid discharge head.

In another example, the liquid discharge device may be an integrated unit in which a liquid discharge head is integrated with a carriage.

In still another example, the liquid discharge device may be the liquid discharge head movably held by a guide that forms part of a main-scanning moving device, so that the liquid discharge head and the main-scanning moving device are integrated as a single unit. The liquid discharge device may include the liquid discharge head, the carriage, and the main scan moving unit that are integrated as a single unit.

In another example, the cap that forms part of the maintenance unit is secured to the carriage mounting the liquid discharge head so that the liquid discharge head, the carriage, and the maintenance unit are integrated as a single unit to form the liquid discharge device.

Further, in another example, the liquid discharge device includes tubes connected to the head tank or the channel member mounted on the liquid discharge head so that the liquid discharge head and the supply assembly are integrated as a single unit. Liquid is supplied from a liquid reservoir source to the liquid discharge head.

The main-scan moving unit may be a guide only. The supply unit may be a tube(s) only or a loading unit only.

The term “liquid discharge apparatus” used herein also represents an apparatus including the liquid discharge head or the liquid discharge device to discharge liquid by driving the liquid discharge head. The liquid discharge apparatus may be, for example, an apparatus capable of discharging liquid to a material to which liquid can adhere or an apparatus to discharge liquid toward gas or into liquid.

The liquid discharge apparatus may include devices to feed, convey, and eject the material on which liquid can adhere. The liquid discharge apparatus may further include a pretreatment apparatus to coat a treatment liquid onto the material, and a post-treatment apparatus to coat a treatment liquid onto the material, onto which the liquid has been discharged.

The liquid discharge apparatus may be, for example, an image forming apparatus to form an image on a sheet by discharging ink, or a three-dimensional apparatus to discharge a molding liquid to a powder layer in which powder material is formed in layers, so as to form a three-dimensional article.

In addition, the liquid discharge apparatus is not limited to such an apparatus to form and visualize meaningful images, such as letters or figures, with discharged liquid. For example, the liquid discharge apparatus may be an apparatus to form meaningless images, such as meaningless patterns, or fabricate three-dimensional images.

The above-described term “material on which liquid can be adhered” represents a material on which liquid is at least temporarily adhered, a material on which liquid is adhered and fixed, or a material into which liquid is adhered to permeate. Examples of the “material on which liquid can be adhered” include recording media, such as paper sheet, recording paper, recording sheet of paper, film, and cloth, electronic component, such as electronic substrate and piezoelectric element, and media, such as powder layer, organ model, and testing cell. The “material on which liquid can be adhered” includes any material on which liquid is adhered, unless particularly limited.

Examples of the material on which liquid can be adhered include any materials on which liquid can be adhered even temporarily, such as paper, thread, fiber, fabric, leather, metal, plastic, glass, wood, and ceramic.

The liquid discharge apparatus may be an apparatus to relatively move a liquid discharge head and a material on which liquid can be adhered. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include a treatment liquid coating apparatus to discharge a treatment liquid to a sheet to coat the treatment liquid on the surface of the sheet to reform the sheet surface and an injection granulation apparatus in which a composition liquid including raw materials dispersed in a solution is injected through nozzles to granulate fine particles of the raw materials.

The terms “image formation”, “recording”, “printing”, “image printing”, and “molding” used herein may be used synonymously with each other.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A nozzle plate, comprising:
a nozzle substrate including a nozzle to discharge liquid; and
a liquid-repellent film disposed on a liquid discharge side of the nozzle substrate and including a fluororesin having a fluorine-containing heterocyclic structure with ether linkage in a polytetrafluoroethylene (PTFE) skeleton,
the liquid-repellent film including a slope region that slopes in a direction in which a film thickness of the liquid-repellent film is smaller toward an edge of the nozzle in a peripheral portion of the nozzle.

2. The nozzle plate according to claim 1,
wherein a surface of the liquid-repellent film is flat outside the slope region.

3. The nozzle plate according to claim 1,
wherein σ/m is less than 0.1, where m represents a mean film thickness of film thicknesses of the liquid-repellent film on a circumference apart from the edge of the nozzle by 5 μm on a normal of the edge in a direction away from a center of the nozzle, and σ represents a standard deviation of the film thicknesses.

4. The nozzle plate according to claim 1,
wherein the liquid-repellent film is further disposed on an inner side of the nozzle, and
wherein a film thickness of the liquid-repellent film on the inner side of the nozzle is one tenth or less of a film thickness of a region of the liquid-repellent film outside the slope region.

5. The nozzle plate according to claim 1,
wherein a relation of c<d is satisfied, where c represents a number average molecular weight of the fluororesin in an interface with a foundation in the liquid-repellent film and d represents a number average molecular weight of the fluororesin in an uppermost surface of the liquid-repellent film.

6. The nozzle plate according to claim 1, further comprising a silane-coupling-agent layer interposed between the nozzle substrate and the liquid-repellent film to bond the nozzle substrate and the liquid-repellent film together via the silane-coupling-agent layer.

7. The nozzle plate according to claim 6,
wherein the silane-coupling-agent layer includes an amino group.

8. The nozzle plate according to claim 1,
wherein the surface of the liquid-repellent film on the liquid discharge side has a film thickness in a range of from 1 μm or greater and 3 μm or less.

9. The nozzle plate according to claim 1,
wherein the fluororesin has a glass transition temperature equal to or higher than 200° C.

10. A liquid discharge head comprising the nozzle plate according to claim 1.

11. A liquid discharge device comprising the liquid discharge head according to claim 10 to discharge liquid.

12. The liquid discharge device according to claim 11,
wherein the liquid discharge head is integrated as a single unit with at least one of:
a head tank to store the liquid to be supplied to the liquid discharge head;
a carriage mounting the liquid discharge head;
a supply unit to supply the liquid to the liquid discharge head;
a maintenance unit to maintain and recover the liquid discharge head; and
a main scan moving unit to move the liquid discharge head in a main scanning direction.

13. A liquid discharge apparatus comprising the liquid discharge device according to claim 11 to discharge the liquid.

14. A liquid discharge apparatus comprising the liquid discharge head according to claim 10 to discharge the liquid.

15. A liquid discharge device comprising:
the liquid discharge head according to claim 10; and
a wiper to wipe a nozzle face of the liquid discharge head,
wherein, when the wiper wipes the nozzle face, a contact width of the wiper with the nozzle face in a wiping direction of the wiper is equal to or greater than an opening width of the nozzle and the wiper face-contacts the nozzle face.

16. The liquid discharge device according to claim 15,
wherein the contact width is smaller than a distance between adjacent nozzles in the wiping direction.

17. A liquid discharge apparatus comprising:
the liquid discharge head according to claim 10; and
a wiper to wipe a nozzle face of the liquid discharge head,
wherein, when the wiper wipes the nozzle face, a contact width of the wiper with the nozzle face in a wiping direction of the wiper is equal to or greater than an opening width of the nozzle and the wiper face-contacts the nozzle face.

18. The liquid discharge apparatus according to claim 17,
wherein the contact width is smaller than a distance between adjacent nozzles in the wiping direction.

19. A method of making the nozzle plate according to claim 1, the method comprising:
forming the fluororesin on the nozzle substrate of metal including the nozzle by vapor deposition; and
heating a film of the fluororesin at a temperature equal to or higher than a glass transition temperature of the fluororesin.
